(19) United States
(12) Patent Application Publication
(10) Pub. No.: US 2021/0248528 A1
(43) Pub. Date: Aug. 12, 2021

(54) INFORMATION TECHNOLOGY UTILIZATION EVALUATION DEVICE, INFORMATION TECHNOLOGY UTILIZATION EVALUATION SYSTEM, AND INFORMATION TECHNOLOGY UTILIZATION EVALUATION METHOD

(71) Applicant: Mitsubishi Electric Corporation, Tokyo (JP)

(72) Inventor: Hideaki IWATA, Tokyo (JP)

(73) Assignee: Mitsubishi Electric Corporation, Tokyo (JP)

(21) Appl. No.: 17/047,075

(22) PCT Filed: May 9, 2018
(86) PCT No.: PCT/JP2018/018002

§ 371 Date: Oct. 13, 2020

(51) Int. Cl. G06Q 10/06; G06Q 50/04

(52) U.S. Cl. CPC G06Q 10/0637; G06Q 50/04

(57) ABSTRACT

An information technology utilization evaluation device includes a processor configured to evaluate a current state of a first evaluation element. The first attainment level is a current attainment level of the first evaluation element. The first evaluation element is progress of automation of process management. The processor is further configured to determine a second attainment level by evaluating a current state of a second evaluation element. The second attainment level is a current attainment level of the second evaluation element. The second evaluation element is scale of the set in which information technology is utilized for the process management. The processor is also configured to determine a target level, using the first attainment level and the second attainment level. The target level is an attainment level recommended as a target.

### FIELD

The present invention relates to an information technology utilization evaluation device, an information technology utilization evaluation system, and an information technology utilization evaluation method for evaluating the degree of information technology utilization in the management of a process to be managed.

### BACKGROUND

In order to improve productivity in a factory, in some case, process management is carried out by utilizing information technology (IT). It is possible to improve the productivity of the factory by utilizing IT to collect information from the production site, and analyze and diagnose the collected information, and by utilizing the result of analysis and the result of diagnosis.

Patent Literature 1 discloses a technique for evaluating the current state of productivity on the basis of three elements: the driving force of business innovation, the degree of contribution of IT utilization to innovation, and business characteristics, and calculating a hypothetical expected effect value indicating the expected effect of business innovation from the current state.

### CITATION LIST

### Patent Literature

Patent Literature 1: Japanese Patent Application Laid-open No. 2009-251993

### SUMMARY

### Technical Problem

The technique of Patent Literature 1 described above can present the effect expected from the current state of IT utilization, but cannot provide guidelines on what level of IT utilization should be determined as a future target on the basis of the current state of IT utilization. Therefore, the technique of Patent Literature 1 described above is problematic in that too high a target to reach from the current state may be set, causing an increase in the burden for achieving the target, or too low a target to aim for from the current state may be set, causing a delay in the improvement of process management efficiency.

The present invention has been made in view of the above, and an object thereof is to obtain an information technology utilization evaluation device capable of obtaining guidelines on future target levels on the basis of the current state of IT utilization. Solution to Problem

In order to solve the above problems and achieve the object, An information technology utilization evaluation device according to the present invention comprises: a first attainment level determination unit to determine a first attainment level by evaluating a current state of a first evaluation element, the first attainment level being a current attainment level of the first evaluation element, the first evaluation element being progress of automation through information technology utilization in management of a process to be managed including a set of unitary processes; a second attainment level determination unit to determine a second attainment level by evaluating a current state of a second evaluation element, the second attainment level being a current attainment level of the second evaluation element, the second evaluation element being scale of a set of unitary processes in which information technology is utilized for management in the process to be managed; and a target level determination unit to determine a target level, using the first attainment level and the second attainment level, the target level being an attainment level recommended as a target.

### Advantageous Effects of Invention

The information technology utilization evaluation device according to the present invention can achieve the effect of obtaining guidelines on future target levels on the basis of the current state of IT utilization.

### BRIEF DESCRIPTION OF DRAWINGS

FIG. 1 is a block diagram illustrating a functional configuration of an IT utilization evaluation device according to a first embodiment of the present invention.

FIG. 2 is a block diagram illustrating a hardware configuration of the IT utilization evaluation device according to the first embodiment.

FIG. 3 is a block diagram illustrating an exemplary configuration of a supply chain that is a target of evaluation by the IT utilization evaluation device according to the first embodiment.

FIG. 4 is a block diagram illustrating exemplary configurations of shops that are bases included in the supply chain illustrated in FIG. 3.

FIG. 5 is a diagram for explaining a first evaluation element and a second evaluation element that are evaluated by the IT utilization evaluation device illustrated in FIG. 1.

FIG. 6 is a flowchart illustrating the operation procedure of the IT utilization evaluation device according to the first embodiment.

FIG. 7 is a diagram illustrating an example of inputting configuration details of the supply chain illustrated in FIG. 3.

FIG. 8 is a diagram illustrating an example of a template created by a template creation unit of the IT utilization evaluation device illustrated in FIG. 1.

FIG. 9 is a diagram for explaining the determination of the attainment level of the first evaluation element by an automation determination unit of the IT utilization evaluation device illustrated in FIG. 1.

FIG. 10 is a diagram for explaining the determination of the attainment level of the second evaluation element by a scale determination unit of the IT utilization evaluation device illustrated in FIG. 1.

FIG. 11 is a flowchart illustrating the procedure for calculating the attainment level of the second evaluation element by the scale determination unit illustrated in FIG. 1.

FIG. 12 is a flowchart illustrating the procedure for calculating the attainment level of the second evaluation element by the scale determination unit illustrated in FIG. 1.

FIG. 13 is a first diagram illustrating an example of the result of determination of the attainment level of the first evaluation element by the automation determination unit and the result of determination of the attainment level of the second evaluation element by the scale determination unit illustrated in FIG. 1.

FIG. 14 is a second diagram illustrating an example of the result of determination of the attainment level of the first evaluation element by the automation determination unit and the result of determination of the attainment level of the second evaluation element by the scale determination unit illustrated in FIG. 1.

FIG. 15 is a diagram illustrating an example of presenting the attainment level of the first evaluation element and the attainment level of the second evaluation element by a presentation unit of the IT utilization evaluation device illustrated in FIG. 1.

FIG. 16 is a diagram illustrating a first device that is the IT utilization evaluation device illustrated in FIG. 1 and second devices.

FIG. 17 is a diagram for explaining the contents of level history data stored in a level history storage unit of the IT utilization evaluation device illustrated in FIG. 1.

FIG. 18 is a flowchart illustrating the operation procedure for determining and presenting a target level by the IT utilization evaluation device illustrated in FIG. 1.

FIG. 19 is a diagram illustrating a first example of the result of aggregation of the number of combinations extracted by a target level determination unit of the IT utilization evaluation device illustrated in FIG. 1.

FIG. 20 is a diagram illustrating a second example of the result of aggregation of the number of combinations extracted by the target level determination unit illustrated in FIG. 1.

FIG. 21 is a diagram illustrating a third example of the result of aggregation of the number of combinations extracted by the target level determination unit illustrated in FIG. 1.

FIG. 22 is a diagram illustrating a first example of presenting target levels by the presentation unit illustrated in FIG. 1.

FIG. 23 is a diagram illustrating a second example of presenting target levels by the presentation unit illustrated in FIG. 1.

FIG. 24 is a block diagram illustrating a data storage unit of the IT utilization evaluation device according to a first modification of the first embodiment.

FIG. 25 is a diagram for explaining the contents of profile data stored in a profile storage unit of the data storage unit illustrated in FIG. 24.

FIG. 26 is a flowchart illustrating the operation procedure for determining and presenting a target level by the IT utilization evaluation device according to the first modification of the first embodiment.

FIG. 27 is a block diagram illustrating a data storage unit of the IT utilization evaluation device according to a second modification of the first embodiment.

FIG. 28 is a diagram for explaining the contents of operation history data stored in an operation history storage unit of the data storage unit illustrated in FIG. 27.

FIG. 29 is a flowchart illustrating the operation procedure for determining and presenting a target level by the IT utilization evaluation device according to the second modification of the first embodiment.

FIG. 30 is a flowchart illustrating the operation procedure for determining and presenting a target level by the IT utilization evaluation device according to a third modification of the first embodiment.

FIG. 31 is a block diagram illustrating a functional configuration of an IT utilization evaluation system according to a second embodiment of the present invention.

FIG. 32 is a flowchart illustrating the operation procedure of an IT utilization evaluation device according to a third embodiment of the present invention.

FIG. 33 is a flowchart illustrating the operation procedure of the IT utilization evaluation device according to a first modification of the third embodiment.

FIG. 34 is a flowchart illustrating the operation procedure of the IT utilization evaluation device according to a second modification of the third embodiment.

FIG. 35 is a diagram illustrating an example of presenting target levels by a presentation unit of the IT utilization evaluation device according to the third embodiment.

FIG. 36 is a diagram illustrating an example of information presented by a presentation unit of an IT utilization evaluation device according to a fourth embodiment of the present invention.

### DESCRIPTION OF EMBODIMENTS

Hereinafter, an information technology utilization evaluation device, an information technology utilization evaluation system, and an information technology utilization evaluation method according to embodiments of the present invention will be described in detail with reference to the drawings. The present invention is not limited to the embodiments.

### First Embodiment

An information technology utilization evaluation device according to the first embodiment of the present invention evaluates the degree of IT utilization in the management of a process to be managed. In the following description, an information technology utilization evaluation device is referred to as an IT utilization evaluation device. A “process to be managed” is a target which the IT utilization evaluation device evaluates. One example of such a process to be managed is a supply chain including manufacturing processes in the manufacturing industry. In the supply chain, process management is carried out to improve productivity. The IT utilization evaluation device according to the first embodiment evaluates the degree of IT utilization in process management for the entire supply chain.

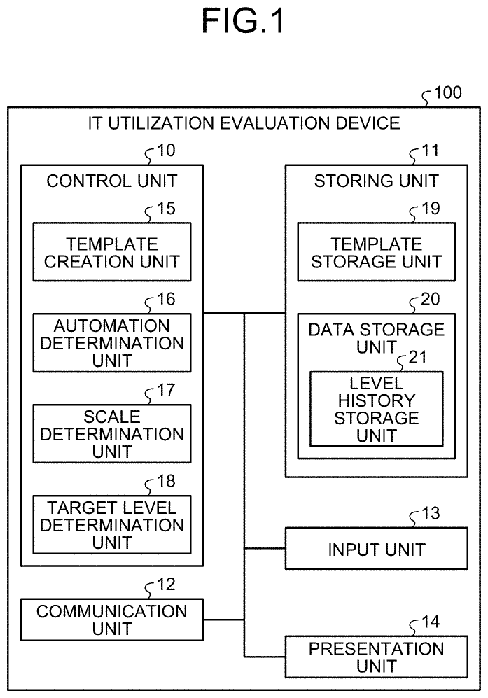

FIG. 1 is a block diagram illustrating a functional configuration of the IT utilization evaluation device 100 according to the first embodiment of the present invention. The IT utilization evaluation device 100 is a computer having an IT utilization evaluation program installed thereon. The IT utilization evaluation program is a program for executing an IT utilization evaluation method. Each functional unit illustrated in FIG. 1 is implemented by executing the IT utilization evaluation program on the computer, which is hardware.

The IT utilization evaluation device 100 includes a control unit 10 which is a functional unit that controls the entire IT utilization evaluation device 100. The control unit 10 includes a template creation unit 15 which is a functional unit that creates a template. Information for use in the evaluation of IT utilization is input to the template. The IT utilization evaluation device 100 includes an automation determination unit 16, a scale determination unit 17, and a target level determination unit 18. The automation determination unit 16 is a first attainment level determination unit. The scale determination unit 17 is a second attainment level determination unit.

The automation determination unit 16 is a functional unit that determines a first attainment level by evaluating the current state of a first evaluation element. The first attainment level is the current attainment level of the first evaluation element. The first evaluation element is the progress of automation through IT utilization in the management of a process to be managed including a set of unitary processes. The automation determination unit 16 determines the first attainment level on the basis of the information input to the template.

The scale determination unit 17 is a functional unit that determines a second attainment level by evaluating the current state of a second evaluation element. The second attainment level is the current attainment level of the second evaluation element. The second evaluation element is the scale of a set of unitary processes in which IT is utilized for management in a process to be managed. The scale determination unit 17 determines the second attainment level on the basis of the information input to the template. The target level determination unit 18 is a functional unit that determines a target level, using the first attainment level and the second attainment level. The target level is an attainment level recommended as a target.

The IT utilization evaluation device 100 includes a storing unit 11 which is a functional unit that stores information. The storing unit 11 includes a template storage unit 19 and a data storage unit 20. The template storage unit 19 is a functional unit that stores a template. The data storage unit 20 is a functional unit that stores various data. The data storage unit 20 includes a level history storage unit 21 that stores level history data indicating a history of attainment levels previously determined. Details of the level history storage unit 21 will be described later.

The IT utilization evaluation device 100 includes a communication unit 12, an input unit 13, and a presentation unit 14. The communication unit 12 is a functional unit that communicates with a device external to the IT utilization evaluation device 100. The input unit 13 is a functional unit that receives input information. The presentation unit 14 is a functional unit that presents information. The presentation unit 14 presents the result of determination of a target level by the target level determination unit 18. The presentation unit 14 also presents the result of determination by the automation determination unit 16 and the result of determination by the scale determination unit 17.

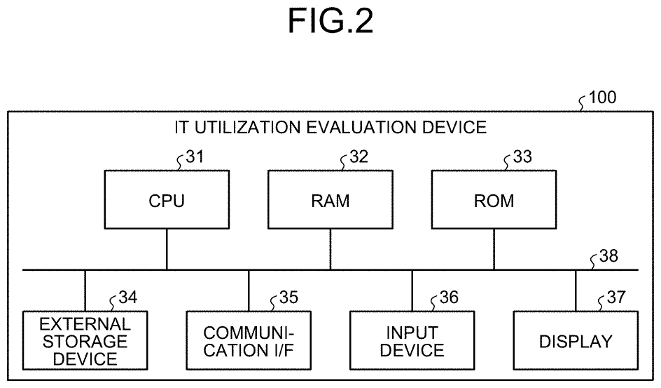

FIG. 2 is a block diagram illustrating a hardware configuration of the IT utilization evaluation device 100 according to the first embodiment. The IT utilization evaluation device 100 includes a central processing unit (CPU) 31 that executes various processes, a random access memory (RAM) 32 including a data storage area, a read only memory (ROM) 33 that is a non-volatile memory, and an external storage device 34. The IT utilization evaluation device 100 includes a communication interface (I/F) 35 that is an interface for connection with a device external to the IT utilization evaluation device 100, an input device 36 that inputs information according to a user operation, and a display 37 which is an output device that displays information on a screen. The components of the IT utilization evaluation device 100 illustrated in FIG. 2 are connected to one another via a bus 38.

The CPU 31 executes programs stored in the ROM 33 and the external storage device 34. The functions of the control unit 10 illustrated in FIG. 1 are implemented by using the CPU 31. The external storage device 34 is a hard disk drive (HDD) or a solid state drive (SSD). The external storage device 34 stores the IT utilization evaluation program, the contents of a template, and a history of attainment levels. The functions of the storing unit 11 illustrated in FIG. 1 are implemented by using the external storage device 34. The ROM 33 stores basic input/output system (BIOS) or unified extensible firmware interface (UEFI), which is a program for controlling the basic operation of the computer, namely the IT utilization evaluation device 100. Note that the IT utilization evaluation program may be stored in the ROM 33.

Programs stored in the ROM 33 and the external storage device 34 are loaded into the RAM 32. The CPU 31 develops the IT utilization evaluation program in the RAM 32 and executes various processes. The input device 36 includes a keyboard and a pointing device. The function of the input unit 13 illustrated in FIG. 1 is implemented by using the input device 36. One example of the display 37 is a liquid crystal display with a liquid crystal panel. The function of the presentation unit 14 illustrated in FIG. 1 is implemented by using the display 37. The function of the communication unit 12 illustrated in FIG. 1 is implemented by using the communication I/F 35.

The IT utilization evaluation program may be stored in a computer-readable storage medium. The IT utilization evaluation device 100 may store, in the external storage device 34, the IT utilization evaluation program stored in the storage medium. The storage medium may be a portable storage medium which is a flexible disk or a flash memory which is a semiconductor memory. The IT utilization evaluation program may be installed on the IT utilization evaluation device 100 from another computer or a server device via a communication network.

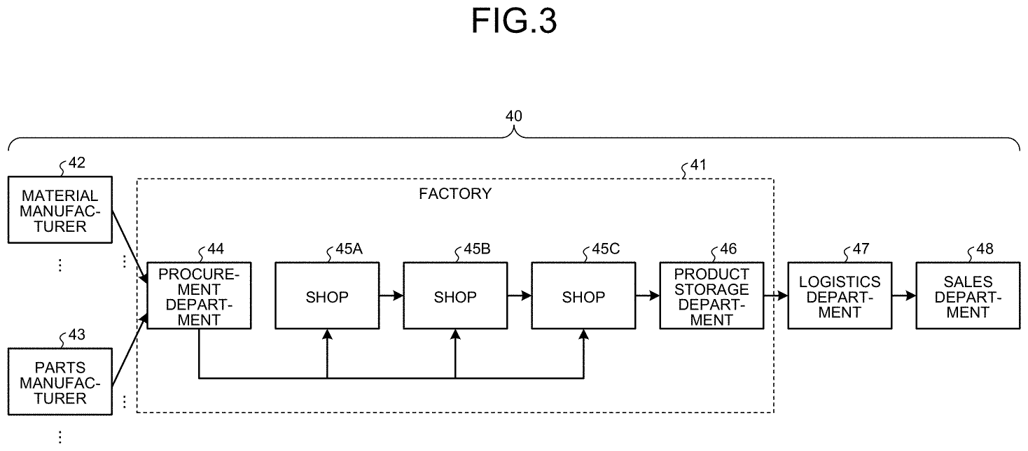

Next, a supply chain that is a target evaluated by the IT utilization evaluation device 100 according to the first embodiment will be described. FIG. 3 is a block diagram illustrating an exemplary configuration of a supply chain 40 that is a target of evaluation by the IT utilization evaluation device 100 according to the first embodiment. In the first embodiment, the supply chain 40 is a whole chain of activities in product production, ranging from the procurement of materials and parts to the sale of products. FIG. 3 depicts a base for each activity in the supply chain 40.

The supply chain 40 includes activities by a material manufacturer 42 that ships product materials, activities by a parts manufacturer 43 that ships product parts, activities by a factory 41 that manufactures products, activities by a logistics department 47 that distributes products, and activities by a sales department 48 that sells products. Activities by the factory 41 include activities by a procurement department 44 that procures materials and parts, activities by shops 45A, 45B, and 45C that are responsible for manufacturing processes, and activities by a product storage department 46 that stores products. The IT utilization evaluation device 100 is installed in the factory 41. In the first embodiment, the user is a person who executes the evaluation of the degree of IT utilization by the IT utilization evaluation device 100. Note that the IT utilization evaluation device 100 may be installed in a place other than the factory 41.

Materials from a plurality of material manufacturers 42 and parts from a plurality of parts manufacturers 43 are delivered to the procurement department 44. The procurement department 44 stores the procured materials and parts in the factory 41. The stored materials and parts are supplied to the shops 45A, 45B, and 45C. Each of the shops 45A, 45B, and 45C is a collection of lines having common manufacturing characteristics. For example, the shop 45A is a collection of lines for processing workpieces. The shop 45B is a collection of lines for assembling processed workpieces. The shop 45C is a collection of lines for inspecting assembled products. The product storage department 46 stores, in the factory 41, the products processed in the shop 45C. The logistics department 47 transports products from the factory 41 to the base of the sales department 48. The sales department 48 sells delivered products. Note that any number of shops may be provided in the factory 41, instead of the three shops.

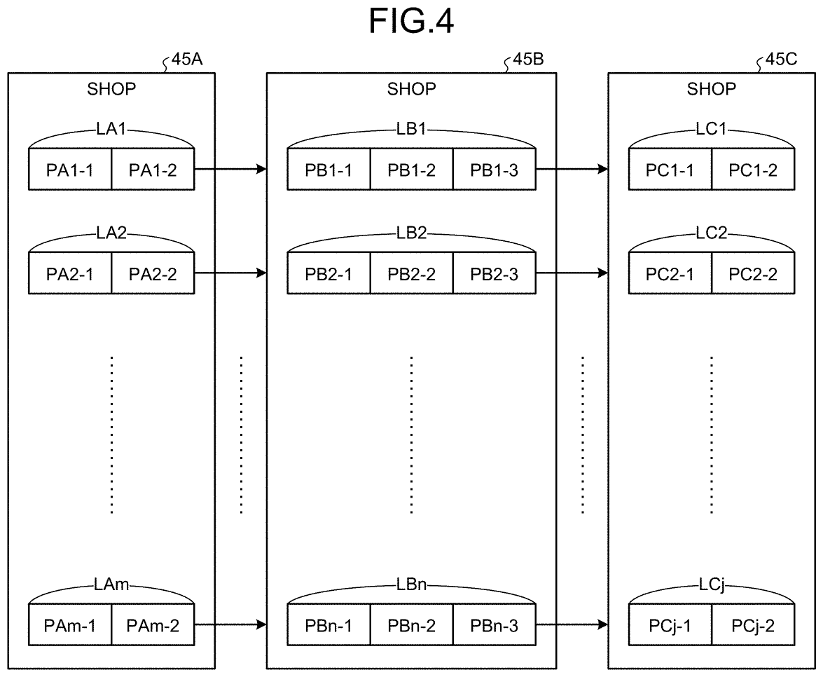

FIG. 4 is a block diagram illustrating exemplary configurations of the shops 45A, 45B, and 45C that are bases included in the supply chain 40 illustrated in FIG. 3. The shop 45A includes m lines. “LA1”, “LA2”, . . . , and “LAm” are the names of the lines included in the shop 45A. All the m lines have common manufacturing characteristics in terms of processing workpieces. The line “LA1” is an array of two unitary processes. A unitary process includes an activity through the operation of equipment according to an instruction or plan. A unitary process may include manual work by an operator. “PA1-1” and “PA1-2” are the names of the unitary processes included in the line “LA1”. Like the line “LA1”, the lines “LA2”, . . . , and “LAm” are also arrays of two unitary processes.

The shop 45B includes n lines. “LB1”, “LB2”, . . . , and “LBn” are the names of the lines included in the shop 45B. All the n lines have common manufacturing characteristics in terms of assembling processed workpieces. The line “LB1” is an array of three unitary processes. “PB1-1”, “PB1-2”, and “PB1-3” are the names of the unit processes included in the line “LB1”. Like the line “LB1”, the lines “LB2”, . . . , and “LBn” are also arrays of three unitary processes.

The shop 45C includes j lines. “LC1”, “LC2”, . . . , and “LCj” are the names of the lines included in the shop 45C. All the j lines have common manufacturing characteristics in inspecting assembled products. The line “LC1” is an array of two unitary processes. “PC1-1” and “PC1-2” are the names of the unit processes included in the line “LC1”. Like the line “LC1”, the lines “LC2”, . . . , and “LCj” are also arrays of two unitary processes.

Like the shops 45A, 45B, and 45C, the procurement department 44 and the product storage department 46, which are bases in the factory, also include lines that are arrays of unit processes. The material manufacturer 42, the parts manufacturer 43, the logistics department 47, and the sales department 48, which are bases outside the factory, also include lines that are arrays of unitary processes. A line is a first set composed of an array of unitary processes. Each of the shops 45A, 45B, and 45C and the bases inside and outside the factory is a second set which is a collection of the first sets. In the following description, the shops 45A, 45B, and 45C and the bases inside and outside the factory may be simply referred to as “shops”. In the following description, “shops” may include the shops 45A, 45B, and 45C and the procurement department 44, the product storage department 46, the material manufacturer 42, the parts manufacturer 43, the logistics department 47, and the sales department 48, which are bases inside and outside the factory.

The supply chain 40 is a third set which is a collection of the second sets. The scale of a set in the supply chain 40 increases stepwise in the order of a line, a shop, and the supply chain 40. Note that not all lines of a shop necessarily include an equal number of unitary processes. A shop may include a line having a different number of unitary processes than other lines. A line does not necessarily include a plurality of unitary processes, and may consist of a single unitary process. A shop does not necessarily include a plurality of lines, and may consist of a single line.

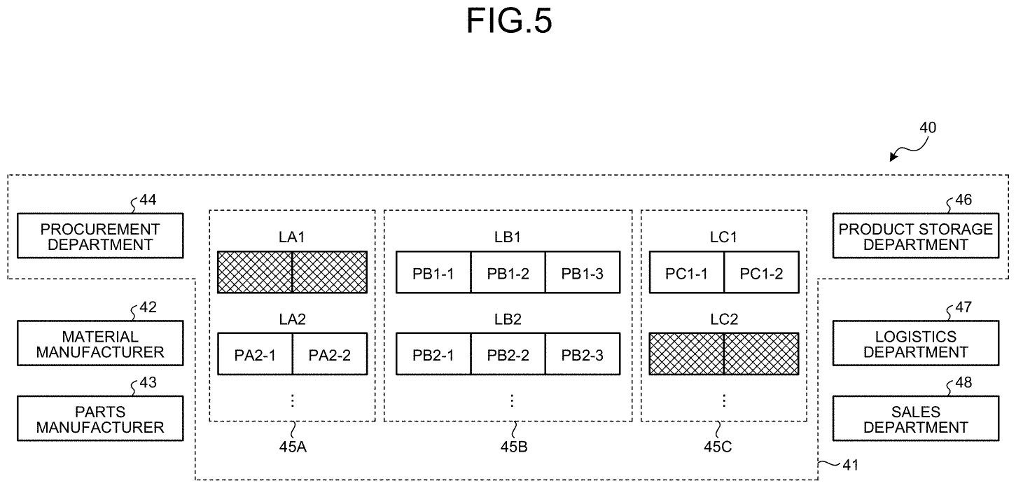

Next, the progress of automation, which is the first evaluation element, and the scale, which is the second evaluation element, will be described. FIG. 5 is a diagram for explaining the first evaluation element and the second evaluation element that are evaluated by the IT utilization evaluation device 100 illustrated in FIG. 1.

In the supply chain 40, the state of equipment, the operation performance of equipment, or the work performance of operators is grasped in each unitary process so that the gap between the production plan and the production performance can be determined and corrective action on the gap can be performed. Further, in some case, work procedures are improved for the purpose of increasing product quality, increasing productivity, and strengthening the ability to meet deadlines for product delivery. For efficient achievement of successful outcomes, it is effective to utilize IT to promote the automation of process management, ranging from information collection for grasping operation performance and work performance to improvement of work procedures. Therefore, in the first embodiment, the progress of automation in the management of unit processes is defined as the first evaluation element.

In the supply chain 40, it is often difficult to collectively introduce IT to all unitary processes. Generally, IT introduction to unitary processes in the supply chain 40 is conducted in a phased manner. It is effective that IT utilization in process management is expanded not only to manufacturing processes in the factory 41 but also to the procurement and storage of materials and parts and the storage, transportation, and sale of products. The expansion of the scale of IT utilization enables efficient achievement of successful outcomes in optimization of production plans based on sales forecasts, optimization of delivery plans for materials and parts, and inventory planning for minimizing inventory. Therefore, in the first embodiment, the scale of a set utilizing IT for the management of unit processes is defined as the second evaluation element. The first embodiment is based on the assumption that the introduction of IT to the supply chain 40 starts in the factory 41 where the IT utilization evaluation device 100 is installed. IT is introduced first to the shops in the factory 41 and then to the shops outside the factory 41.

In the IT utilization evaluation device 100, four levels that are standards for attainment levels of the first evaluation element are defined. The minimum level of the four levels, level “1”, is the level at which collection and accumulation of data for use in process management can be automatically performed. Level “2”, which is one level higher than level “1”, is the level at which, in addition to level “1”, data visualization can be automatically performed for display of collected or accumulated data. Level “3”, which is one level higher than level “2”, is the level at which, in addition to level “2”, data analysis and analytic diagnosis can be automatically performed. Level “4” is one level higher than level “3” and is the maximum level of the four levels. Level “4” is the level at which unit process control can be automatically performed according to the result of diagnosis.

Note that the phrase “can be automatically performed” means that, in principle, no manual work is required for the intended operation, but the operation may partially involve some manual work. For example, an automated task may involve manual input by an operator. The number of levels as standards for attainment levels is not limited to four. Any number of levels may be prepared as standards. Further, the definition of each level of automation is not limited to the above content, and may be changed as appropriate. Definitions are preset in the IT utilization evaluation device 100. Definitions may be set by the user.

The supply chain 40 can include a unitary process in which IT cannot be utilized for the management function. A unitary process in which IT cannot be utilized for the management function is exemplified by a sensory test. The IT utilization evaluation device 100 may exclude the unitary process that is not targeted for IT introduction, and determine the attainment level of the first evaluation element and the attainment level of the second evaluation element in the supply chain 40. In the example illustrated in FIG. 5, the management function in each unitary process of the two hatched lines “LA1” and “LC2” is not targeted for IT introduction. In the shops 45A, 45B, and 45C, each management process of the lines other than “LA1” and “LC2” is targeted for IT introduction. The IT utilization evaluation device 100 may exclude the lines “LA1” and “LC2” and determine the attainment level of the first evaluation element and the attainment level of the second evaluation element.

In the IT utilization evaluation device 100, four levels that are standards for attainment levels of the second evaluation element are defined. The minimum level of the four levels, level “1”, indicates that the factory 41 includes one or more unitary processes in which IT has been installed. For example, assume that IT has not been installed in any of the unit processes illustrated in FIG. 5. In this case, the condition of level “1” is satisfied by the introduction of IT to one unitary process “PB2-2”.

Level “2”, which is one level higher than level “1”, indicates that the factory 41 includes one or more lines in which IT has been introduced for all unitary processes. For example, assume that IT has been introduced in the unitary process “PB2-2” of the line “LB2”. In this case, the condition of level “2” is satisfied by the introduction of IT to the remaining two unitary processes “PB2-1” and “PB2-3” of the line “LB2”.

Level “3”, which is one level higher than level “2”, indicates that IT has been introduced to all the lines in the factory 41, except lines including a unit process that is not targeted for IT introduction. Level “4” is one level higher than level “3” and is the maximum level of the four levels. Level “4” indicates that IT has been introduced to all the lines of the supply chain 40, except lines including a unit process that is not targeted for IT introduction. In this way, the definitions of the four levels represent the status of IT introduction to unit processes.

For the scale level to increase by one from “1”, “2”, or “3”, it will require a great deal of man-hours and labor to introduce IT. In a situation where IT is being introduced little by little, if the evaluation does not change at all just because the definition of the level at each stage is not satisfied, it means that the current state of IT introduction is not considered in the evaluation, and that a proper and useful evaluation cannot be conducted. To avoid this, the IT utilization evaluation device 100 is capable of determining attainment levels intermediate between the defined stepwise levels, so that the current state of IT introduction can be reflected in evaluation.

IT is introduced in the factory 41 in two cases: where IT is introduced in a shop including a line in which IT introduction has been completed; and where IT is newly introduced to a shop that does not include a line in which IT introduction has been completed. Comparing these two cases, the latter case of new introduction is more difficult to achieve than the former case. In view of this, the IT utilization evaluation device 100 is capable of level determination in which such new introduction is rated at a higher attainment level than other cases when achieved, so that evaluation can be conducted in a manner commensurate with the degree of difficulty in IT introduction.

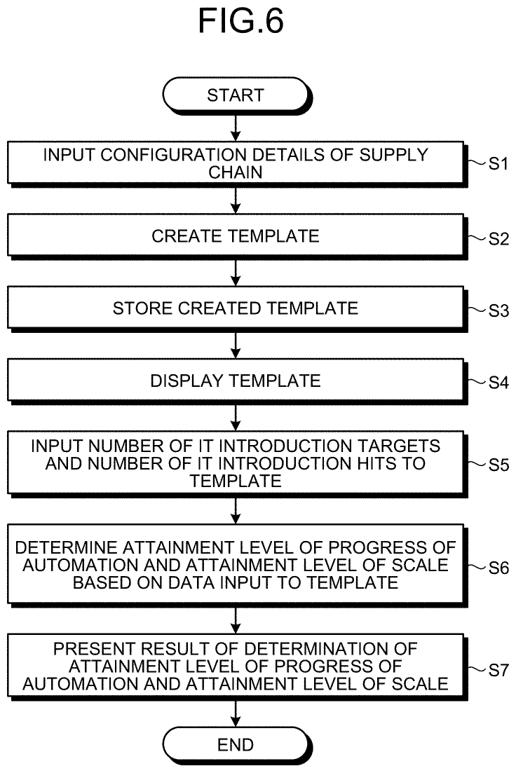

FIG. 6 is a flowchart illustrating the operation procedure of the IT utilization evaluation device 100 according to the first embodiment. In the procedure illustrated in FIG. 6, steps S1 to S3 are processes for preparing a template, which processes are executed before processes for evaluation. In step S1, the input unit 13 illustrated in FIG. 1 receives inputs of configuration details of the supply chain 40, which is a process to be managed. The presentation unit 14 illustrated in FIG. 1 displays an input format. Data is input to the input format through user's manual input, whereby configuration details of the supply chain 40 are input into the input unit 13.

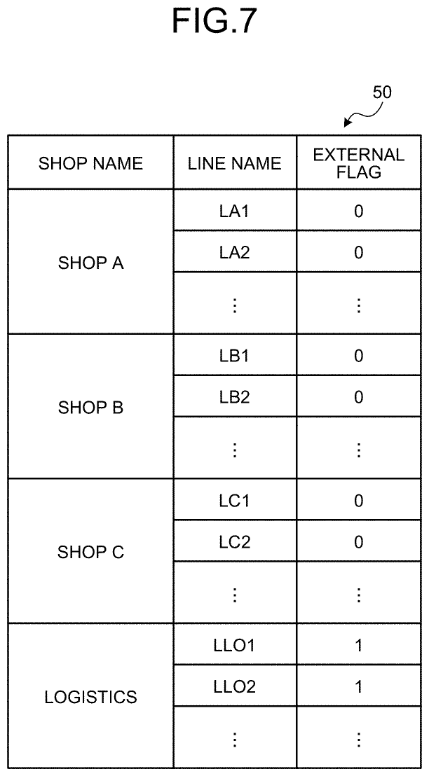

FIG. 7 is a diagram illustrating an example of inputting configuration details of the supply chain 40 illustrated in FIG. 3. An input format 50 illustrated in FIG. 7 contains entry fields for shop names, entry fields for line names, and entry fields for external flags. A shop name is the name of each shop included in the supply chain 40. “Shop A” is the name of the shop 45A illustrated in FIG. 3. “Shop B” is the name of the shop 45B. “Shop C” is the name of the shop 45C. “Logistics” is the name of the logistics department 47. The shop names “shop A”, “shop B”, “shop C”, and “logistics” are input in the input format 50.

Input to the line name field corresponding to “shop A” are the names “LA1”, “LA2”, etc. of the lines of the shop 45A. Input to the line name field corresponding to “shop B” are the names “LB1”, “LB2”, etc. of the lines of the shop 45B. Input to the line name field corresponding to “shop C” are the names “LC1”, “LC2”, etc. of the lines of the shop 45C. Input to the line name field corresponding to “logistics” are the names “LL01”, “LL02”, etc. of the lines of the logistics department 47.

An external flag is a flag indicating whether each line is a line inside the factory 41 or a line outside the factory 41. In the example illustrated in FIG. 7, the flag “0” represents the inside of the factory 41. The flag “1” represents the outside of the factory 41. “0” is input in the flag field corresponding to each line of “shop A”, “shop B”, and “shop C”. “1” is input in the flag field corresponding to each line of “logistics”. Note that, in step S1, information about unitary processes included in lines is not input.

In step S2, the IT utilization evaluation device 100 creates a template in the template creation unit 15 illustrated in FIG. 1. The template creation unit 15 creates a template on the basis of the data input in step S1. Once the creation of the template is completed, the IT utilization evaluation device 100 stores the created template in the template storage unit 19 in step S3.

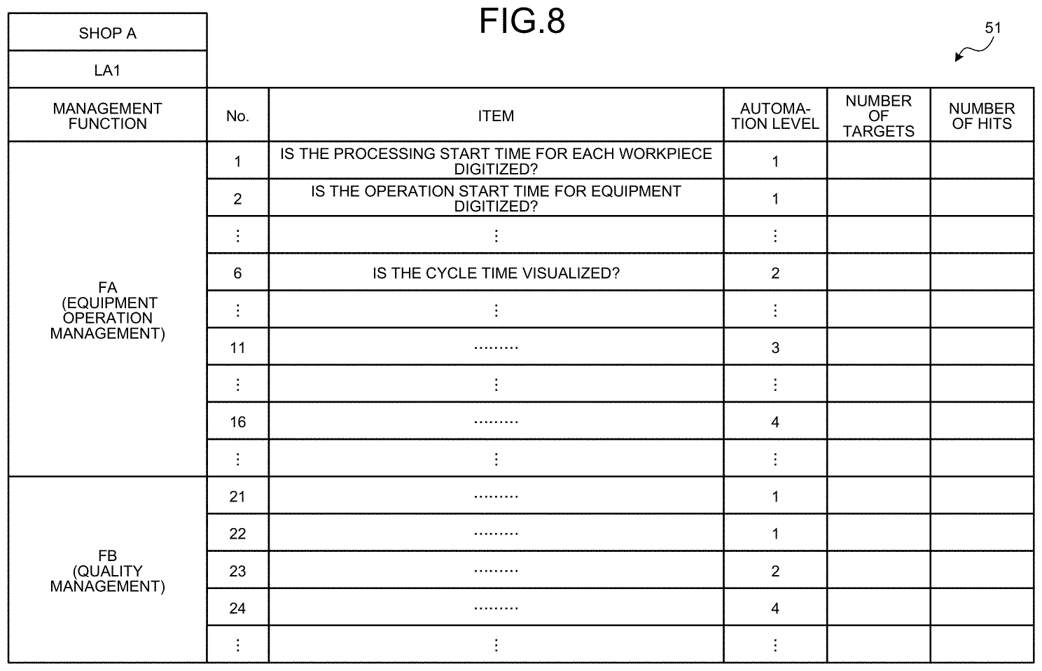

FIG. 8 is a diagram illustrating an example of a template 51 created by the template creation unit 15 of the IT utilization evaluation device 100 illustrated in FIG. 1. FIG. 8 depicts a part of the template 51 for the line “LA1” of the shop 45A. The template creation unit 15 creates the template 51 on a line-by-line basis for all the lines included in the supply chain 40 on the basis of the data input in step S1.

The template 51 contains fields indicating a shop name and a line name, fields indicating the names of management functions, fields indicating the contents of items for each management function, fields indicating the automation level set for each item, entry fields for the number of targets, and entry fields for the number of hits. Management functions are process management functions in which IT is utilized. “FA” is a name that represents equipment operation management, which is one type of management function. “FB” is a name that represents quality management, which is one type of management function. In addition to the equipment operation management and the quality management, management functions may include other management functions that can be included in process management. Management functions may include volume management.

The items are points for checking the status of automation in the management of unit processes, which points are set in question form. Each item included in the template 51 is numbered. In the template 51 illustrated in FIG. 8, a plurality of items corresponding to the management function “FA” is set. Among them, the item “No. 1” “Is the processing start time for each workpiece digitized?” is a point to be checked regarding the automation of collection and accumulation of processing start time data for use in the equipment operation management. The item “No. 6” “Is the cycle time visualized?” is a point to be checked regarding the automation of visualization of cycle time data for use in the equipment operation management. Items related to automation are also set for management functions other than the management function “FA”.

Automation levels indicate to which of the four levels, namely, the standards for attainment levels of the first evaluation element, the automation contents specified as items correspond. As for the item “No. 1”, digitization of the processing start time for each workpiece corresponds to automatic collection and accumulation of data, which is the definition of level “1” above. Therefore, the automation level of “No. 1” is “1”. As for the item “No. 6”, visualization of the cycle time corresponds to automatic data visualization, which is the definition of level “2” above. Therefore, the automation level of “No. 6” is “2”. Automation levels are similarly assigned to the other items.

The template creation unit 15 creates the common template 51 for all lines regardless of which shop the lines belong to. Data on management functions, items, and automation levels as materials for the template 51 are stored in the template storage unit 19 in advance. Note that the automation level for each item may be settable by the user.

The number of targets represents the number of unitary processes targeted for IT introduction among the unitary processes included in the line. The number of hits represents the number of unitary processes in which IT has already been introduced. The number of targets and the number of hits are information indicating the current state of IT utilization. The template 51 contains, on an item-by-item basis, an entry field for the number of targets and an entry field for the number of hits.

After the preparation of the template 51 through the processes of steps S1 to S3 is completed, the IT utilization evaluation device 100 executes evaluation using the processes of step S4 and subsequent steps. When executing evaluation, the control unit 10 illustrated in FIG. 1 reads the template 51 from the template storage unit 19. In step S4, the presentation unit 14 illustrated in FIG. 1 displays the read template 51. In step S5, the input unit 13 illustrated in FIG. 1 receives inputs of the number of IT introduction targets and the number of IT introduction hits to the template. The number of targets and the number of hits are input to the template through user's manual input.

Input to the field of the number of targets for the item “No. 1” in the template 51 illustrated in FIG. 8 is the number of unitary processes targeted for digitization of the processing start time for each workpiece, among the unitary processes of the line LA1. Input to the field of the number of hits for the item “No. 1” is the number of unitary processes in which the processing start time for each workpiece has already been digitized, among the unit processes of the line LA1. Similarly, the number of targets and the number of hits are input for the other items. The ratio of the number of hits to the number of targets represents the progress of automation for each item. By excluding the number of unitary processes that are not targeted for IT introduction from the number of targets, the IT utilization evaluation device 100 can determine the attainment level on the basis of the progress of automation for each item that reflects the actual situation.

The example illustrated in FIG. 8 is based on the assumption that the lines included in “logistics” include no unitary process that should satisfy the item “No. 1”. In the template 51 for these lines, “0” is input as the number of targets for the item “No. 1”, whereby the lines are excluded from the evaluation targets for the item “No. 1”. The IT utilization evaluation device 100 can determine the attainment level after excluding the data on the unitary processes that do not include the evaluation targets. As a result, it is possible to avoid a situation in which the evaluation of the progress of automation in the lines does not reflect the actual situation and remains low.

In step S6, on the basis of the data on the number of targets and the number of hits input to the template 51, the automation determination unit 16 illustrated in FIG. 1 determines the attainment level of the progress of automation through IT utilization for the entire supply chain 40. The automation determination unit 16 quantifies the degree of progress of automation into the attainment level of the first evaluation element, which is the progress of automation. In step S6, on the basis of the data on the number of targets and the number of hits input to the template 51, the scale determination unit 17 illustrated in FIG. 1 determines the attainment level of the scale of a set of unitary processes in which IT is utilized for management in the entire supply chain 40. The scale determination unit 17 quantifies the scale of a set in which IT is utilized, into the attainment level of the second evaluation element, which is the scale. In step S7, the presentation unit 14 presents the result of determination of the attainment level of the progress of automation and the attainment level of the scale in step S6. Then, the IT utilization evaluation device 100 ends the operation illustrated in FIG. 6.

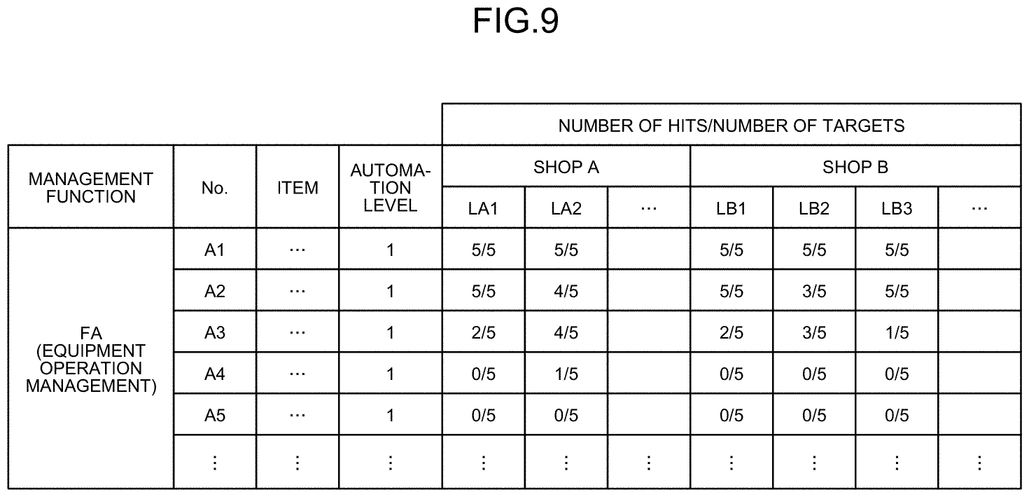

Next, the determination of the attainment level of the first evaluation element by the automation determination unit 16 will be described. FIG. 9 is a diagram for explaining the determination of the attainment level of the first evaluation element by the automation determination unit 16 of the IT utilization evaluation device 100 illustrated in FIG. 1. The automation determination unit 16 determines the attainment level of the first evaluation element for each management function on the basis of the information input to the template 51 illustrated in FIG. 8. FIG. 9 depicts the items having the automation level “1”, and the number of targets and the number of hits for these items, among the items of the management function “FA” illustrated in FIG. 8 for the lines of “shop A” and “shop B” in the supply chain 40. In the data illustrated in FIG. 9, the items identical to those illustrated in FIG. 8 are grouped together by management function, and numbered. The items of the management function “FA” are numbered “A1”, “A2”, etc.

The automation determination unit 16 calculates the attainment level of the first evaluation element by management function and by automation level set for items. Using Formula (1) below, the automation determination unit 16 calculates the attainment level Y₁ of the first evaluation element for the items having the automation level “1”. In Formula (1), N_{F1} is the number of items having the automation level “1” among the items grouped together by management function. N_{A1} is the number of items including one or more hits among the items having the automation level “1”.

Y₁=N_{A1}/N_{F1} (1)

In the data illustrated in FIG. 9, among the items of the management function “FA”, five items from “No. A1” to “No. A5” have the automation level “1”. In this case, N_{F1}=5 is satisfied. Among these five items, four items from “No. A1” to “No. A4” include one or more hits, so N_{A1}=4 is satisfied. Therefore, Y₁=4/5=0.8 is calculated using Formula (1).

Using Formulas (2) to (4) below, the automation determination unit 16 calculates the attainment levels Y₂, Y₃, and Y₄ for the items having the automation levels “2”, “3”, and “4”, respectively. In Formula (2), N_{F2} is the number of items having the automation level “2” among the items grouped together by management function. N_{A2} is the number of items including one or more hits among the items having the automation level “2”. In Formula (3), N_{F3} is the number of items having the automation level “3” among the items grouped together by management function. N_{A3} is the number of items including one or more hits among the items having the automation level “3”. In Formula (4), N_{F4} is the number of items having the automation level “4” among the items grouped together by management function. N_{A4} is the number of items including one or more hits among the items having the automation level “4”.

Y₂=(N_{A2}/N_{F2})+1 (2)

Y₃=(N_{A3}/N_{F3})+2 (3)

Y₄=(N_{A4}/N_{F4})+3 (4)

For the management functions other than the management function “FA”, the automation determination unit 16 calculates the attainment level of the first evaluation element for each automation level set for items, as in the case of the management function “FA”.

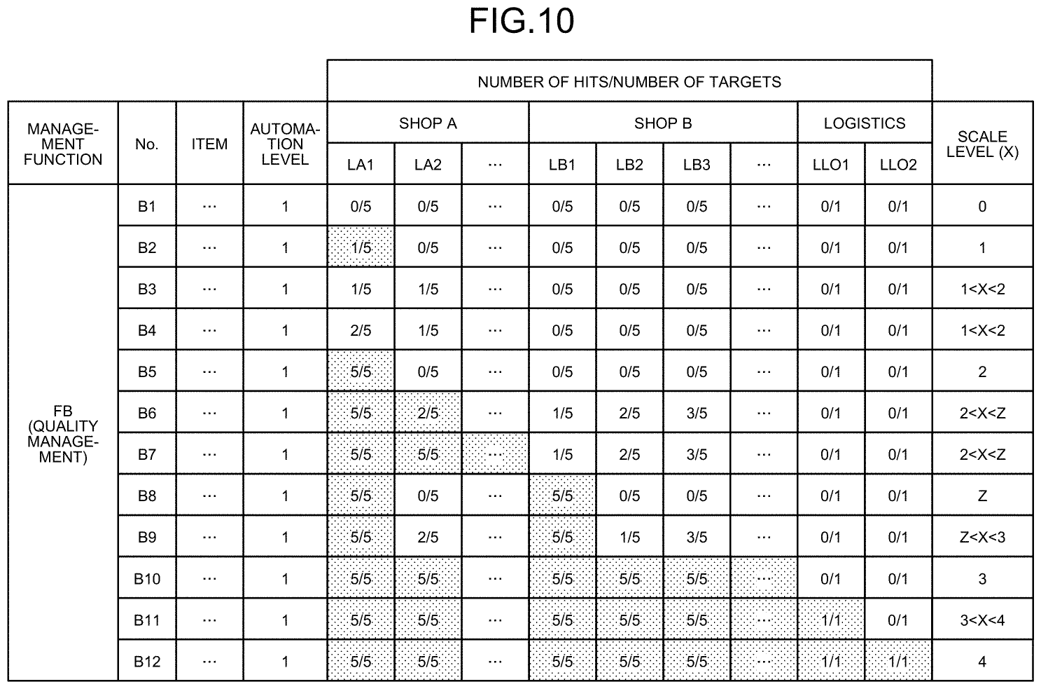

Next, the determination of the attainment level of the second evaluation element by the scale determination unit 17 will be described. FIG. 10 is a diagram for explaining the determination of the attainment level of the second evaluation element by the scale determination unit 17 of the IT utilization evaluation device 100 illustrated in FIG. 1. On the basis of the information input to the template 51 illustrated in FIG. 8, the scale determination unit 17 determines the attainment level of the second evaluation element by management function. FIG. 10 depicts the items having the automation level “1”, and the number of targets and the number of hits for these items, among the items of the management function “FB” illustrated in FIG. 8 for the lines of “shop A”, “shop B”, and “logistics” in the supply chain 40. In the data illustrated in FIG. 10, the items identical to those illustrated in FIG. 8 are grouped together by management function, and numbered. The items of the management function “FB” are numbered “B1”, “B2”, etc.

The scale determination unit 17 calculates the attainment level of the second evaluation element by management function and by automation level set for items. The scale determination unit 17 calculates the attainment levels X_{B1}, X_{B2}, etc. for the respective items on the basis of the data provided by the template 51 for each line. The scale determination unit 17 averages the attainment levels X_{B1}, X_{B2}, etc. for the respective items to thereby calculate the attainment level X₁ of the second evaluation element for the items having the automation level “1”.

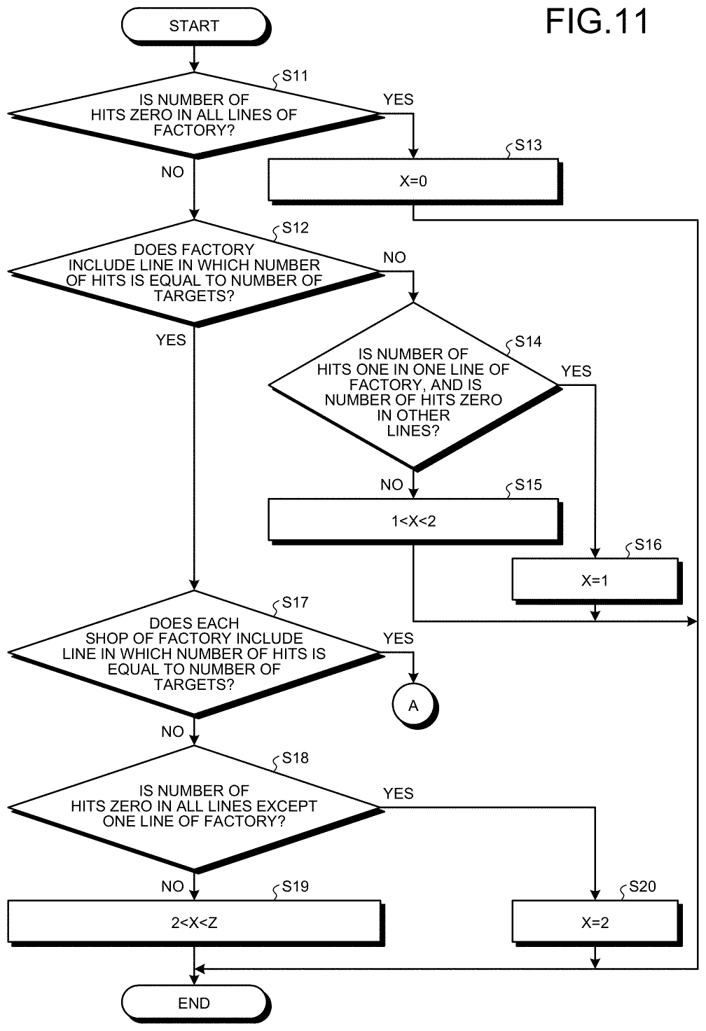

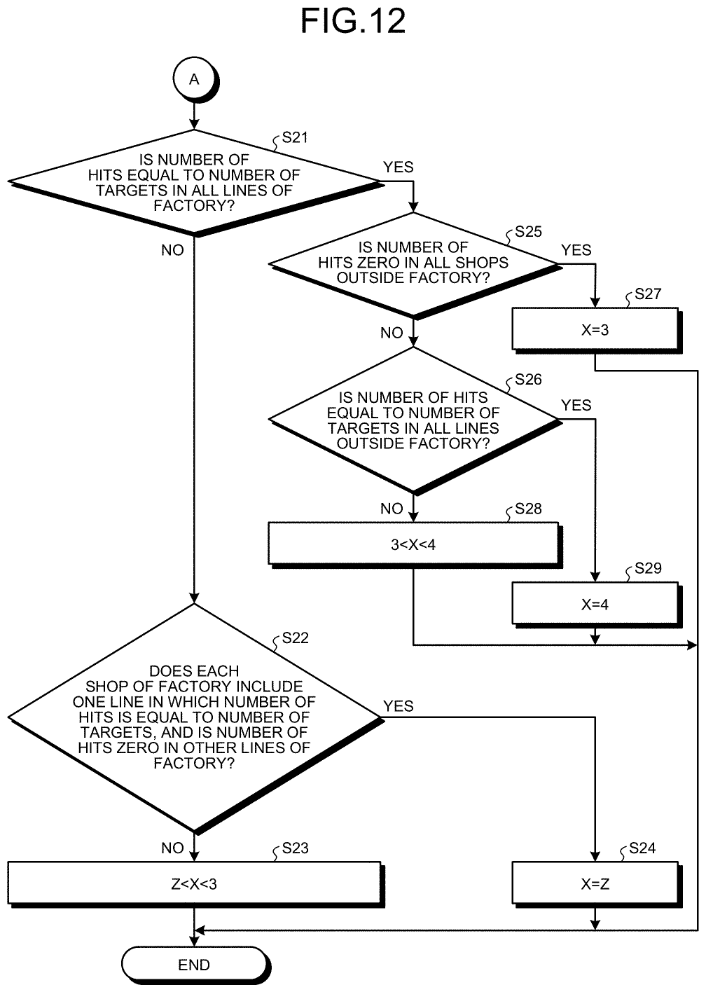

FIGS. 11 and 12 are flowcharts illustrating the procedure for calculating the attainment level of the second evaluation element by the scale determination unit 17 illustrated in FIG. 1. In step S11, the scale determination unit 17 refers to the templates 51 for all the lines of the factory 41 and determines whether the number of hits is zero in all the lines of the factory 41. If the number of hits is zero in all the lines of the factory 41 (step S11: Yes), the scale determination unit 17 calculates the attainment level of the second evaluation element as X=0 in step S13.

Referring to the data illustrated in FIG. 10, the number of hits for the item “No. B1” is zero in all the lines in the factory 41 including the lines of “shop A” and “shop B”. Because the condition of step S1l is satisfied, the scale determination unit 17 calculates the attainment level X=X_{B1} of the second evaluation element for the item “No. B1” as X_{B1}=0 in step S13.

If the number of hits is other than zero in one or more lines of the factory 41 (step S11: No), the scale determination unit 17 determines in step S12 whether the factory 41 includes a line in which the number of hits is equal to the number of targets. If the factory 41 does not include a line in which the number of hits is equal to the number of targets (step S12: No), the scale determination unit 17 determines in step S14 whether the number of hits is one in one line of the factory 41 and the number of hits is zero in the other lines. If the number of hits is one in one line and the number of hits is zero in the other lines (step S14: Yes), the scale determination unit 17 calculates the attainment level as X=1 in step S16.

Referring to the data illustrated in FIG. 10, for the item “No. B2”, the number of hits is one in one line LA1 and the number of hits is zero in the other lines. Because the condition of step S12 is not satisfied, but the condition of step S14 is satisfied, the scale determination unit 17 calculates the attainment level X=X_{B2} for the item “No. B2” as X_{B2}=1 in step S16.

If the condition that the number of hits is one in one line and the number of hits is zero in the other lines is not satisfied (step S14: No), the scale determination unit 17 calculates X that satisfies 1<X<2 in step S15. In step S15, the scale determination unit 17 calculates the attainment level X of the second evaluation element, using Formula (5) below. In Formula (5), N_{BA} is the total number of targets in the factory 41. N_{BLI} is the number of lines in the factory 41. N_{BB} is the total number of hits in the factory 41. In Formula (5), X is the logarithm of N_{BB} to base N_{BA}−N_{BLI}+1. In step S15, the scale determination unit 17 may calculate the attainment level X of the second evaluation element, using a formula other than Formula (5) below.

X=log[N_{BA}−N_{BLI}+1]N_{BB} (5)

Referring to the data illustrated in FIG. 10, the items “No. B3” and “No. B4” satisfy neither the condition of step S12 nor the condition of step S14. In step S15, the scale determination unit 17 calculates, for the items “No. B3” and “No. B4”, the attainment level X=X_{B3} and the attainment level X=X_{B4} that satisfy 1<X<2.

If the factory 41 includes a line in which the number of hits is equal to the number of targets (step S12: Yes), the scale determination unit 17 determines in step S17 whether each shop of the factory 41 includes a line in which the number of hits is equal to the number of targets. If the factory 41 includes a shop that does not have a line in which the number of hits is equal to the number of targets (step S17: No), the scale determination unit 17 determines in step S18 whether the number of hits is zero in all the lines except one line of the factory 41.

If the number of hits is zero in all the lines except one line (step S18: Yes), the scale determination unit 17 calculates the attainment level as X=2 in step S20. Referring to the data illustrated in FIG. 10, the item “No. B5” does not satisfy the condition of step S17, but satisfies the condition of step S18. In step S20, the scale determination unit 17 calculates the attainment level X=X_{B5} for the item “No. B5” as X_{B5}=2. If the condition that the number of hits is zero in all the lines except one line is not satisfied (step S18: No), the scale determination unit 17 calculates X that satisfies 2<X<Z in step S19. Z is any value satisfying 2<Z<3. In the first embodiment, Z=2.6 is set.

In step S19, the scale determination unit 17 calculates the attainment level X of the second evaluation element, using Formula (6) below. In Formula (6), N_{BLI} is the number of lines in the factory 41. N_{BSI} is the number of shops in the factory 41. N_{BBLI} is the number of lines in the factory 41 in which the number of hits is equal to the number of targets. In step S19, the scale determination unit 17 may calculate the attainment level X of the second evaluation element using a formula other than Formula (6).

X=2+(Z−2)log[N_{BLI}−N_{BSI}+1]N_{BBLI} (6)

Referring to the data illustrated in FIG. 10, the items “No. B6” and “No. B7” satisfy neither the condition of step S17 nor the condition of step S18. In step S19, the scale determination unit 17 calculates, for the items “No. B6” and “No. B7”, the attainment level X=X_{B6} and the attainment level X=X_{B7} that satisfy 2<X<Z.

If each shop of the factory 41 includes a line in which the number of hits is equal to the number of targets (step S17: Yes), the scale determination unit 17 determines in step S21 whether the number of hits is equal to the number of targets in all the lines of the factory 41. If the factory 41 includes a line in which the number of hits is not equal to the number of targets (step S21: No), the scale determination unit 17 advances the procedure to step S22. In step S22, the scale determination unit 17 determines whether each shop of the factory 41 includes one line in which the number of hits is equal to the number of targets, and whether the number of hits is zero in the other lines of the factory 41.

If the condition of step S22 is satisfied (step S22: Yes), the scale determination unit 17 calculates the attainment level as X=Z in step S24. The item “No. B8” does not satisfy the condition of step S21, but satisfies the condition of step S22. In step S24, the scale determination unit 17 calculates the attainment level X=X_{B8} for the item “No. B8” as X_{B8}=Z. For the item “No. B8”, IT introduction has been completed in all the unitary processes targeted for IT introduction in the first line “LB1” of “shop B” unlike the items “No. B6” and “No. B7”. The scale determination unit 17 determines that the item “No. B8” has a higher degree of IT utilization than the items “No. B6” and “No. B7” as “shop B” includes a line in which IT introduction has been completed.

If the condition of step S22 is not satisfied (step S22: No), the scale determination unit 17 calculates X that satisfies Z<X<3 in step S23. In step S22, the scale determination unit 17 calculates the attainment level X of the second evaluation element, using Formula (7) below. In Formula (7), N_{BLI} is the number of lines in the factory 41. N_{BSI} is the number of shops in the factory 41. N_{BBLI} is the number of lines in the factory 41 in which the number of hits is equal to the number of targets. The scale determination unit 17 may calculate the attainment level X of the second evaluation element, using a formula other than Formula (7).

X=Z+(3−Z)log[N_{BLI}−N_{BSI+}1]N_{BBLI} (7)

Referring to the data illustrated in FIG. 10, the item “No. B9” satisfies neither the condition of step S21 nor the condition of step S22. In step S23, the scale determination unit 17 calculates the attainment level X=X_{B9} for the item “No. B9” that satisfies Z<X<3.

If the number of hits is equal to the number of targets in all the lines of the factory 41 (step S21: Yes), the scale determination unit 17 determines in step S25 whether the number of hits is zero in all the shops outside the factory 41. If the number of hits is zero in all the shops outside the factory 41 (step S25: Yes), the scale determination unit 17 calculates the attainment level as X=3 in step S27. The item “No. B10” satisfies both the condition of step S21 and the condition of step S25. In step S27, the scale determination unit 17 calculates the attainment level X=X_{B10} for the item “No. B10” as X_{B10}=3.

If the number of hits is other than zero in one or more shops outside the factory 41 (step S25: No), the scale determination unit 17 determines in step S26 whether the number of hits is equal to the number of targets in all the lines outside the factory 41. If the number of hits is equal to the number of targets in all the lines outside the factory 41 (step S26: Yes), the scale determination unit 17 calculates the attainment level as X=4 in step S29.

The item “No. B12” does not satisfy the condition of step S25, but satisfies the condition of step S26. In step S29, the scale determination unit 17 calculates the attainment level X=X_{B12} for the item “No. B12” as X_{B12}=4.

If the number of hits is not equal to the number of targets in one or more lines outside the factory 41 (step S26: No), the scale determination unit 17 calculates X that satisfies 3<X<4 in step S28. In step S28, the scale determination unit 17 calculates the attainment level X of the second evaluation element, using Formula (8) below. In Formula (8), N_{BLO} is the number of lines outside the factory 41. N_{BSO} is the number of shops outside the factory 41. N_{BBLO} is the number of lines outside the factory 41 in which the number of hits is equal to the number of targets. The scale determination unit 17 may calculate the attainment level X of the second evaluation element, using a formula other than Formula (8).

X=3+log[N_{BLO}−N_{BSO}+1]N_{BBLO} (8)

Referring to the data illustrated in FIG. 10, the item “No. B11” satisfies neither the condition of step S25 nor the condition of step S26. In step S28, the scale determination unit 17 calculates the attainment level X=X_{B11} for the item “No. B11” that satisfies 3<X<4.

The scale determination unit 17 averages the attainment levels X_{B1}, . . . , and X_{B12} for the respective items, using Formula (9) below to thereby calculate the attainment level X₁ of the second evaluation element for the items having the automation level “1”. N_{N} of Formula (9) is the value obtained by subtracting the number of items in which the number of hits is zero in all the lines in the factory 41 from the number of items having the automation level “1”. Referring to the data illustrated in FIG. 10, the item “No. B1” corresponds to an item in which the number of hits is zero in all the lines in the factory 41. Subtracting 1 from 12 that is the number of items from “No. B1” to “No. B12” provides N_{N} that is 11.

X₁=(X_{B1}+X_{B2}+ . . . +X_{B12})/N_{N} (9)

The scale determination unit 17 calculates the attainment levels X₂, X₃, and X₄ of the second evaluation element for the items having the automation levels “2”, “3”, and “4”, respectively, as in the case of the attainment level X₁ of the second evaluation element for the items having the automation level “1”. Further, for the management functions other than the management function “FB”, the scale determination unit 17 calculates the attainment level of the second evaluation element for each automation level set for items, as in the case of the management function “FB”.

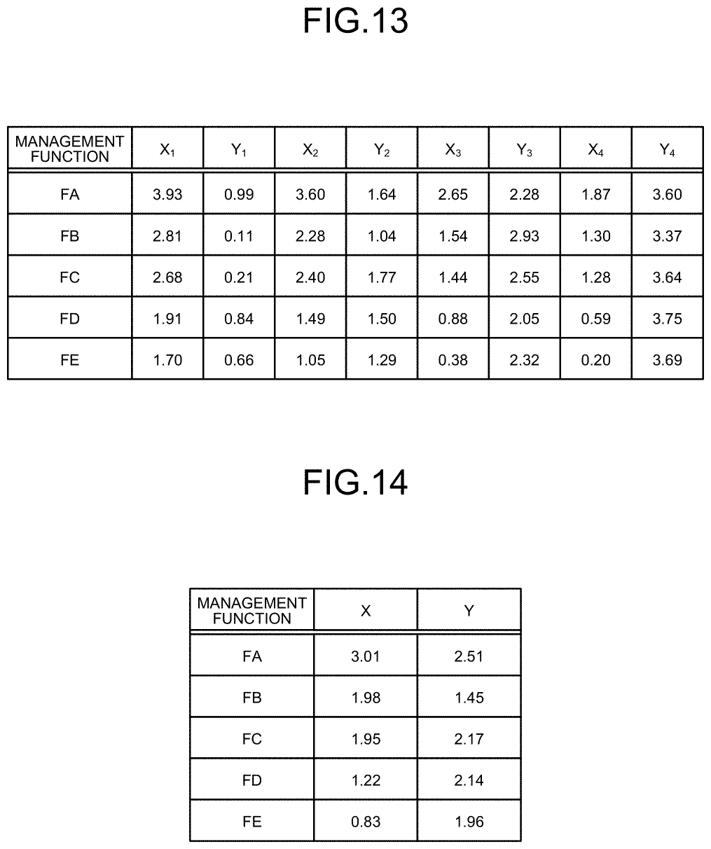

FIG. 13 is a first diagram illustrating an example of the result of determination of the attainment level of the first evaluation element by the automation determination unit 16 and the result of determination of the attainment level of the second evaluation element by the scale determination unit 17 illustrated in FIG. 1. Y₁, Y₂, Y₃, and Y₄ illustrated in FIG. 13 represent the results of calculation of the attainment levels of the first evaluation element by the automation determination unit 16 for the automation levels “1”, “2”, “3”, and “4” set for each item. X₁, X₂, X₃, and X₄ represent the results of calculation of the attainment levels of the second evaluation element by the scale determination unit 17 for the automation levels “1”, “2”, “3”, and “4” set for each item. FIG. 13 depicts the results of calculation of the attainment levels X₁, X₂, X_{3,} and X₄ of the second evaluation element and the results of calculation of the attainment levels Y₁, Y₂, Y₃, and Y₄ of the first evaluation element for the five management functions “FA”, “FB”, “FC”, “FD”, and “FE”.

FIG. 14 is a second diagram illustrating an example of the result of determination of the attainment level of the first evaluation element by the automation determination unit 16 and the result of determination of the attainment level of the second evaluation element by the scale determination unit 17 illustrated in FIG. 1. Using Formula (10) below, the automation determination unit 16 calculates the attainment level Y of the first evaluation element for each management function. The attainment level Y is the average of the attainment levels Y₁, Y₂, Y₃, and Y₄ of the first evaluation element for each management function. By calculating the attainment level Y, the automation determination unit 16 integrates the four results of determination regarding the attainment level of the first evaluation element, into one.

Y=Y₁+(Y₂−1)+(Y₃−2)+(Y₄−3) (10)

Using Formula (11) below, the scale determination unit 17 calculates the attainment level X of the second evaluation element for each management function. The attainment level X is the average of the attainment levels X₁, X₂, X₃, and X₄ of the second evaluation element for each management function. By calculating the attainment level X, the scale determination unit 17 integrates the four results of determination regarding the attainment level of the second evaluation element. into one. FIG. 14 depicts the results of calculation of the attainment levels X of the second evaluation element and the results of calculation of the attainment levels Y of the first evaluation element for the five management functions “FA”, “FB”, “FC”, “FD”, and “FE”.

X=(X₁+X₂+X₃+X₄)/4 (11)

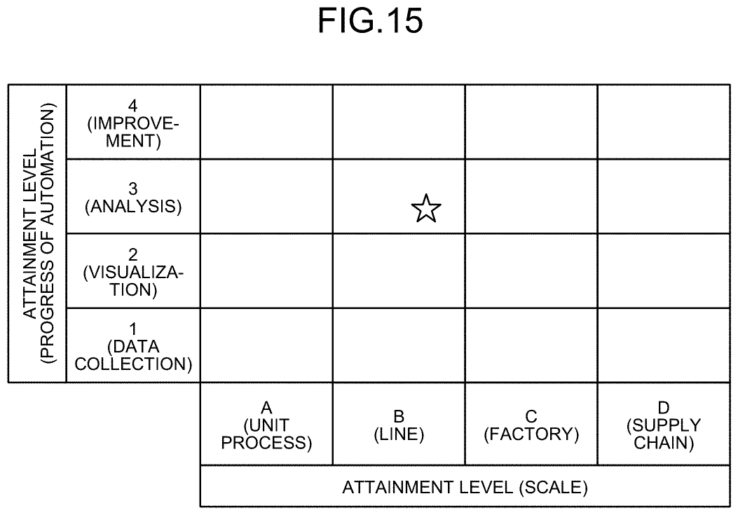

FIG. 15 is a diagram illustrating an example of presenting the attainment level of the first evaluation element and the attainment level of the second evaluation element by the presentation unit 14 of the IT utilization evaluation device 100 illustrated in FIG. 1. In the example illustrated in FIG. 15, the presentation unit 14 displays a matrix in which the vertical axis represents the attainment level of the progress of automation, which is the first evaluation element, and the horizontal axis represents the attainment level of the scale, which is the second evaluation element.

The attainment levels “1”, “2”, “3”, and “4” on the vertical axis represent the above-mentioned levels “1”, “2”, “3”, and “4”, respectively, which are the standards for attainment levels of the first evaluation element. The attainment levels “A”, “B”, “C”, and “D” on the horizontal axis represent the above-mentioned levels “1”, “2”, “3”, and “4”, respectively, which are the standards for attainment levels of the second evaluation element.

The presentation unit 14 displays, on the matrix, a point indicating the result of determination of the attainment level of the first evaluation element and the result of determination of the attainment level of the second evaluation element. In the example illustrated in FIG. 15, the presentation unit 14 displays a star-shaped mark at the position of the point. As a result, the IT utilization evaluation device 100 can present the current attainment levels of the first evaluation element and the second evaluation element to the user in an easy-to-understand manner.

In the example illustrated in FIG. 15, the results of calculation of X and Y for the five management functions illustrated in FIG. 14 are integrated into one point for display. The point illustrated in FIG. 15 indicates the average of X values and the average of Y values for the five management functions. The presentation unit 14 may display points indicating the results of determination by management function. The presentation unit 14 may also display the numerical values of the results of determination illustrated in FIG. 14 together with the graph. The presentation unit 14 may add the results of determination regarding process management in a plurality of factories 41 to the presentation. As a result, the user can compare the degrees of IT utilization for process management in the plurality of factories 41.

The IT utilization evaluation device 100 determines the attainment level of the progress of automation through IT utilization and the attainment level of the scale of a set in which IT is utilized. The IT utilization evaluation device 100 can evaluate the progress status of the automation of management through IT utilization and the expansion of the range in which IT is used for management. As a result, the IT utilization evaluation device 100 can conduct a useful and quantitative evaluation of the degree of IT utilization.

Next, the determination of a target level by the target level determination unit 18 will be described. Using the first attainment level and the second attainment level, the target level determination unit 18 illustrated in FIG. 1 determines a target level, i.e. an attainment level recommended as a target.

The level history storage unit 21 illustrated in FIG. 1 stores level history data indicating a history of attainment levels determined in a first device, i.e. the IT utilization evaluation device 100 used by the user. In the following description, level history data indicating a history of first attainment levels and second attainment levels previously determined by the IT utilization evaluation device 100 may be referred to as “own level history data”.

The level history storage unit 21 constructs own level history data by accumulating the results of determination by the automation determination unit 16 and the results of determination by the scale determination unit 17. The level history storage unit 21 stores, in addition to the own level history data, level history data indicating a history of first attainment levels and second attainment levels determined by a second device, i.e. an IT utilization evaluation device used by a user other than the user of the first device. In this way, the level history storage unit 21 stores level history data indicating a history of attainment levels previously determined by the second device, which is an IT utilization evaluation device other than the first device. In the following description, level history data indicating a history of first attainment levels and second attainment levels determined by the second device may be referred to as “other-device level history data”. On the basis of the “other-device level history data” stored in the level history storage unit 21, the target level determination unit 18 determines a target level for the IT utilization evaluation device 100, which is the first device. The target level determination unit 18 may determine a target level on the basis of the “own level history data” in addition to determining a target level on the basis of the “other-device level history data”.

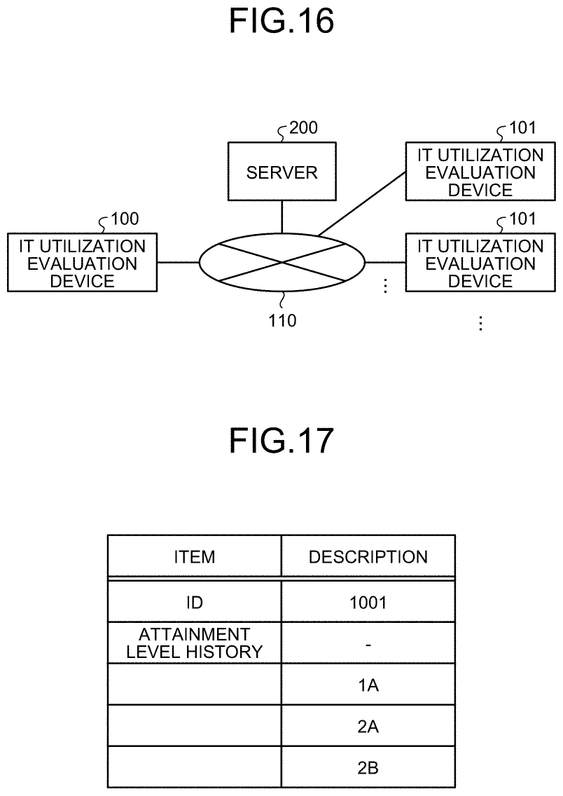

FIG. 16 is a diagram illustrating the first device that is the IT utilization evaluation device 100 illustrated in FIG. 1 and second devices. A plurality of IT utilization evaluation devices 101, namely the second devices, are connected to the IT utilization evaluation device 100 via a communication network 110. The communication network 110 is the Internet, which is a wide area network. The IT utilization evaluation device 101 is a computer having the IT utilization evaluation program installed thereon. The IT utilization evaluation device 101 has the same configuration as the IT utilization evaluation device 100.

In each IT utilization evaluation device 101, level history data is constructed in the same manner as in the IT utilization evaluation device 100. A server 200 holds the level history data constructed by the IT utilization evaluation device 100 and the level history data constructed by each IT utilization evaluation device 101. The server 200 is connected to the communication network 110. The server 200 provides the held level history data to all the IT utilization evaluation devices 100 and 101. The communication unit 12 illustrated in FIG. 1 transmits, to the server 200, the own level history data constructed by the IT utilization evaluation device 100. The communication unit 12 receives the other-device level history data transmitted from the server 200.

The server 200 manages the level history data of each of the IT utilization evaluation devices 100 and 101 by holding the level history data constructed in each of the IT utilization evaluation devices 100 and 101. In addition, each of the IT utilization evaluation devices 100 and 101 may hold the constructed level history data. The level history data of each of the IT utilization evaluation devices 100 and 101 may be managed by being distributed to the IT utilization evaluation devices 100 and 101 in addition to being managed by the server 200.

FIG. 17 is a diagram for explaining the contents of level history data stored in the level history storage unit 21 of the IT utilization evaluation device 100 illustrated in FIG. 1. FIG. 17 depicts the contents of own level history data. The level history data include the ID assigned to the IT utilization evaluation device 100. “1001” for the item “ID” represents the ID of the IT utilization evaluation device 100. IDs are used to identify the IT utilization evaluation device 100 and other IT utilization evaluation devices 101.

In the item “attainment level history”, own level history data are stored in time-series order. After the attainment level of the first evaluation element is calculated, the automation determination unit 16 converts the value of the calculated attainment level into an integer. After the attainment level of the second evaluation element is calculated, the scale determination unit 17 converts the value of the calculated attainment level into an integer. The automation determination unit 16 and the scale determination unit 17 convert the values of attainment levels into integers by rounding the value of a calculated attainment level with a decimal point up to an integer. The automation determination unit 16 and the scale determination unit 17 may convert the values of attainment levels into integers by rounding a value with a decimal point down to an integer, rounding a value with a decimal point to the nearest integer, or using another method.

The automation determination unit 16 converts the first attainment level into any of “1”, “2”, “3”, and “4”. The scale determination unit 17 converts the second attainment level into any of “1”, “2”, “3”, and “4”. The scale determination unit 17 further converts the integers “1”, “2”, “3”, and “4” obtained through conversion, into the alphabetical letters “A”, “B”, “C”, and “D”, respectively. The integers obtained through conversion by the automation determination unit 16 and the scale determination unit 17 may include “0”.

The level history storage unit 21 stores a combination of an integer representing the first attainment level and an alphabetical letter representing the second attainment level. In this manner, the level history storage unit 21 constructs own level history data by accumulating combinations of integers, i.e. values indicating results of determination of the first attainment level, and alphabetical letters, i.e. values indicating results of determination of the second attainment level.

“1A” for the item “attainment level history” represents a combination of “1” indicating a result of determination of the first attainment level and “A” indicating a result of determination of the second attainment level. “2A” next to “1A” is a combination of “2” indicating a result of determination of the first attainment level and “A” indicating a result of determination of the second attainment level. “2A” is the combination of results of determination obtained after “1A”. “2B” is the combination of results of determination obtained after “2A”.

Each IT utilization evaluation device 101 also constructs level history data including combinations of results of determination of the first attainment level and results of determination of the second attainment level in the same manner as the IT utilization evaluation device 100 constructs level history data.

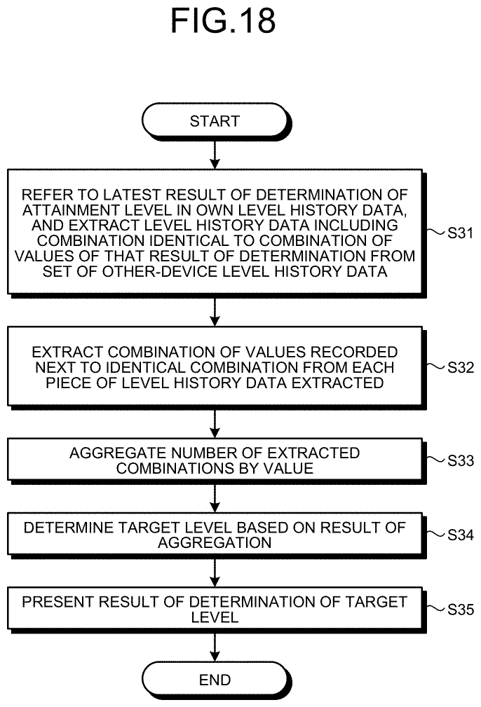

FIG. 18 is a flowchart illustrating the operation procedure for determining and presenting a target level by the IT utilization evaluation device 100 illustrated in FIG. 1. In step S31, the target level determination unit 18 reads, from the level history storage unit 21, the most recently recorded combination of a value indicating the first attainment level, namely the attainment level of the first evaluation element, and a value indicating the second attainment level, namely the attainment level of the second evaluation element. In this way, the target level determination unit 18 refers to the latest result of determination of the attainment level in the own level history data in step S31.

In step S31, the target level determination unit 18 extracts, from a set of other-device level history data, level history data including a combination identical to the combination of values of the referred result of determination. In a case where the latest combination is “2B”, the target level determination unit 18 extracts, from a set of other-device level history data, all level history data including the combination “2B”.

In step S32, the target level determination unit 18 extracts, from each piece of level history data extracted in step S31, the combination of values recorded next to the combination identical to the combination referred to in step S31. In a case where the combination referred to in step S31 is “2B”, the target level determination unit 18 extracts, from each piece of level history data extracted, the combination recorded next to the combination “2B”.

Assume that the level history data of one IT utilization evaluation device 101 among the extracted level history data include a time series of combinations “1A”, “2A”, “2B”, “3B”, “3C”, and “4C”. In this case, the target level determination unit 18 extracts, from the level history data, “3B” recorded next to “2B”. In this way, the target level determination unit 18 refers to the transition of the first attainment level previously determined and the transition of the second attainment level previously determined from the extracted level history data.

In step S32, in a case where the combination identical to the combination referred to in step S31 is the latest combination in the level history data, the target level determination unit 18 may extract the latest combination. In a case where “2B” is the latest combination in the level history data of the IT utilization evaluation device 101, the target level determination unit 18 may extract the combination “2B” from the level history data.

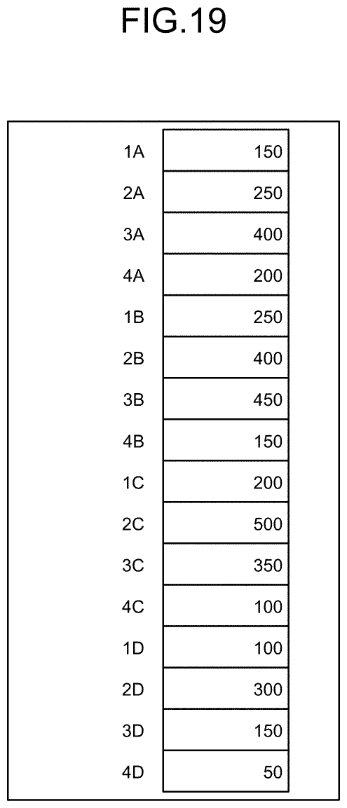

In step S33, the target level determination unit 18 aggregates the number of combinations extracted in step S32 by value. FIG. 19 is a diagram illustrating a first example of the result of aggregation of the number of combinations extracted by the target level determination unit 18 of the IT utilization evaluation device 100 illustrated in FIG. 1. FIG. 19 depicts combinations of values indicating the first attainment level and values indicating the second attainment level, and the number of combinations aggregated by value. For example, the value “450” in the field adjacent to “3B” represents the number of combinations “3B” extracted from pieces of level history data in step S32.

The number of combinations represents the frequency of each combination recorded next to the combination “2B” in a set of other-device level history data. The result of aggregation illustrated in FIG. 19 shows that the combination with the highest frequency among the combinations recorded next to the combination “2B” is “2C”, with the number of combinations “2C” extracted being “500”, which is the maximum value in the result of aggregation. The result also shows that the combination with the second highest frequency next to “2C” is “3B”, with the number of combinations “3B” extracted being “450”.

According to the example illustrated in FIG. 19, the combination “1A” in which both the first attainment level and the second attainment level are reduced from “2B”, the combinations “1B”, “1C”, and “1D” in which the first attainment level is reduced from “2B”, and the combinations “2A”, “3A”, and “4A” in which the second attainment level is reduced from “2B” may exist next to the combination “2B”. For example, in a case where a new line is added to the supply chain 40, at least one of the first attainment level and the second attainment level can be reduced because the new line has not undergone IT introduction.

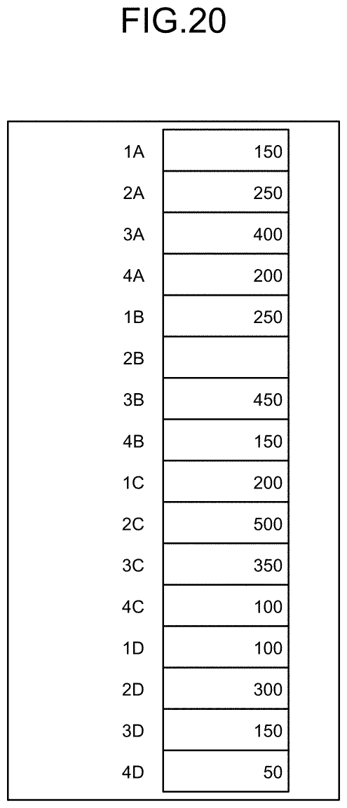

In step S32, in a case where the combination identical to the combination referred to in step S31 is the latest combination in the level history data, the target level determination unit 18 need not extract the combination. FIG. 20 is a diagram illustrating a second example of the result of aggregation of the number of combinations extracted by the target level determination unit 18 illustrated in FIG. 1. FIG. 20 depicts an example of the result of aggregation in which the latest combination is not extracted. In a case where “2B” is the latest combination in the level history data of the IT utilization evaluation device 101, no combination is extracted from the level history data, so the field adjacent to “2B” is blank.

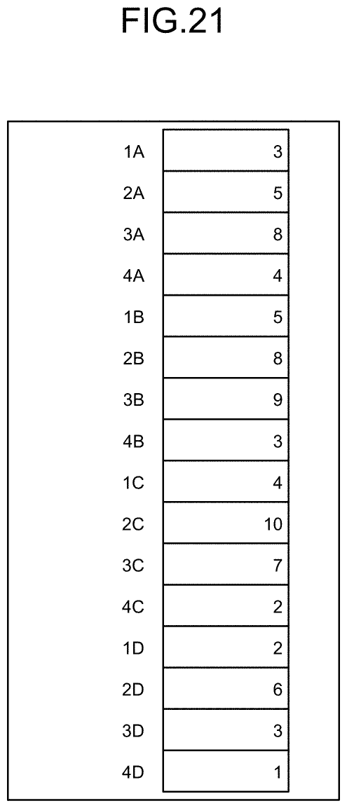

In step S32, the target level determination unit 18 may normalize the number of combinations aggregated. FIG. 21 is a diagram illustrating a third example of the result of aggregation of the number of combinations extracted by the target level determination unit 18 illustrated in FIG. 1. FIG. 21 depicts an example of the result of aggregation in which the number of combinations extracted is normalized, the normalized number being up to 10. The target level determination unit 18 replaces the number of combinations aggregated by value with an integer of 1 to 10 according to the frequency indicated by the number of combinations.

In step S34, the target level determination unit 18 determines a target level on the basis of the result of aggregation in step S33. In the first embodiment, the target level determination unit 18 designates the combination having the highest frequency, as a target level. In a case where the results of aggregation illustrated in FIGS. 19, 20, and 21 are obtained, the target level determination unit 18 designates the combination “2C” having the highest frequency, as the target level that should be achieved next to the current attainment level “2B”. The target level determination unit 18, which performs the target level determination in step S34 on the basis of the result of aggregation in step S33, determines the target level through statistical processing using a set of other-device level history data collected from a plurality of users. In this way, the target level determination unit 18 determines the target level by referring to the transition of the first attainment level previously determined and the transition of the second attainment level previously determined from the extracted level history data.

In step S35, the presentation unit 14 presents the result of determination of the target level in step S34. Then, the IT utilization evaluation device 100 ends the operation illustrated in FIG. 18. Note that the first attainment level and the second attainment level in step S31 are not limited to current attainment levels, but may be past attainment levels recorded in the level history data. In the first embodiment, the “current state” may include not only the current situation but also the past situation.

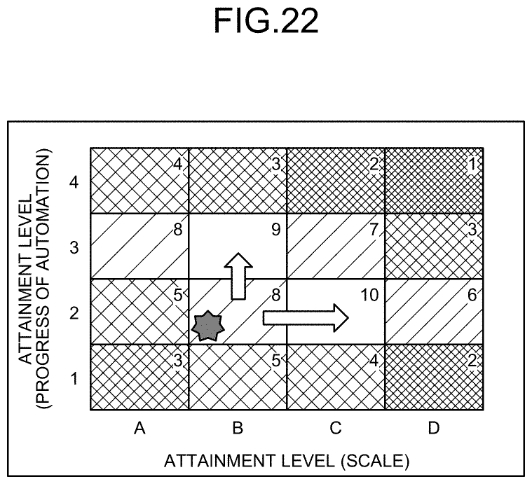

FIG. 22 is a diagram illustrating a first example of presenting target levels by the presentation unit 14 illustrated in FIG. 1. In the example illustrated in FIG. 22, the presentation unit 14 displays a matrix in which the vertical axis represents the attainment level of the progress of automation, which is the first evaluation element, and the horizontal axis represents the attainment level of the scale, which is the second evaluation element. The presentation unit 14 arranges cells, each representing a combination, in a two-dimensional direction to display the combinations. On the matrix, the presentation unit 14 displays a point indicating the first attainment level, i.e. the current attainment level of the first evaluation element, and the second attainment level, i.e. the current attainment level of the second evaluation element.

The presentation unit 14 presents a target level with an arrow pointing from the cell representing the current attainment level to the cell representing the target level. In the example illustrated in FIG. 22, the presentation unit 14 shows that the target level is “2C”, using the arrow pointing from the “2B” cell to the “2C” cell. As a result, the IT utilization evaluation device 100 can present, to the user in an easy-to-understand manner, the target level to be achieved from the current state of the first evaluation element and the second evaluation element.

In step S34 described above, the target level determination unit 18 may determine a plurality of target levels. The target level determination unit 18 may designate, as two target levels, the combination with the highest frequency and the combination with the second highest frequency next to that combination. The target level determination unit 18 determines the first target level “2C” determined to be most recommended and the second target level “3B” determined to be second most recommended next to the first target level. FIG. 22 depicts an example of presenting target levels after the first target level and the second target level are determined.

In the example illustrated in FIG. 22, the presentation unit 14 presents the first target level “2C” and the second target level “3B” by making the arrow pointing from the “2B” cell to the “3B” cell shorter than the arrow pointing from the “2B” cell to the “2C” cell. As a result, the presentation unit 14 can present, to the user in an easy-to-understand manner, the first target level as the first candidate and the second target level as the second candidate to be achieved from the current state of the first evaluation element and the second evaluation element.

In the example illustrated in FIG. 22, the presentation unit 14 color-codes each cell indicating a combination for display. The presentation unit 14 makes the target levels stand out by color-coding each cell such that cells indicating combinations having higher frequencies stand out more. As a result, the presentation unit 14 can present the target levels to the user in an easy-to-understand manner.

In the example illustrated in FIG. 22, the presentation unit 14 adds a value representing a normalized result of aggregation, to each cell indicating a combination. As a result, the presentation unit 14 can present the results of aggregation together with the target levels in an easy-to-understand manner. The presentation unit 14 may add the value of an unnormalized result of aggregation, instead of a normalized result of aggregation. Still, the presentation unit 14 can present the results of aggregation together with the target levels in an easy-to-understand manner.

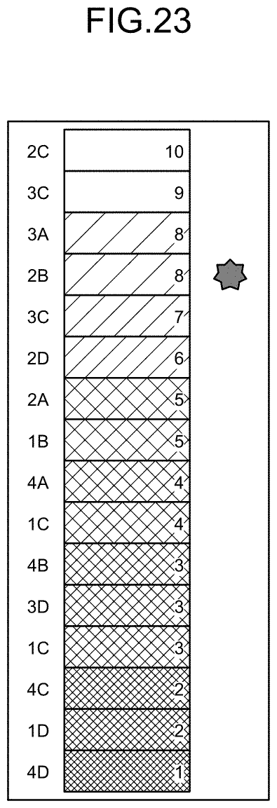

FIG. 23 is a diagram illustrating a second example of presenting target levels by the presentation unit 14 illustrated in FIG. 1. In the example illustrated in FIG. 23, the presentation unit 14 arranges cells, each representing a combination, in a one-dimensional direction to display the combinations. The presentation unit 14 places the cell indicating the combination having the highest frequency at the top, and places the cells indicating the other combinations in descending order of frequency. The presentation unit 14 displays a point indicating the current attainment levels of the first evaluation element and the second evaluation element adjacent to the cell indicating the combination of that attainment levels. As a result, the presentation unit 14 can present the target levels to the user in an easy-to-understand manner. The presentation unit 14 can present, to the user in an easy-to-understand manner, the recommended order of target levels to be achieved from the current state of the first evaluation element and the second evaluation element.

In the example illustrated in FIG. 23, the presentation unit 14 color-codes each cell indicating a combination for display, as in the example illustrated in FIG. 22. As a result, the presentation unit 14 can present the target levels to the user in an easy-to-understand manner. In the example illustrated in FIG. 23, the presentation unit 14 adds a value representing a normalized result of aggregation to each cell indicating a combination, as in the example illustrated in FIG. 22. As a result, the presentation unit 14 can present the results of aggregation together with the target levels in an easy-to-understand manner. The presentation unit 14 may add the value of an unnormalized result of aggregation, instead of a normalized result of aggregation.

According to the first embodiment, the IT utilization evaluation device 100 includes the target level determination unit 18 that determines a target level, i.e. an attainment level recommended as a target, using the first attainment level and the second attainment level. From the IT utilization evaluation device 101 in which a combination identical to the combination of values indicating the latest result of determination of the first attainment level and the second attainment level is recorded in the level history data, the target level determination unit 18 designates, as a target level, the attainment level having the highest frequency among the attainment levels recorded next to the identical combination. Using the result of statistical processing of other-device level history data by the target level determination unit 18, the user can formulate an IT introduction plan based on the tendency of IT introduction by a plurality of users. As a result, the IT utilization evaluation device 100 can achieve the effect of obtaining guidelines on future target levels on the basis of the current state of IT utilization.

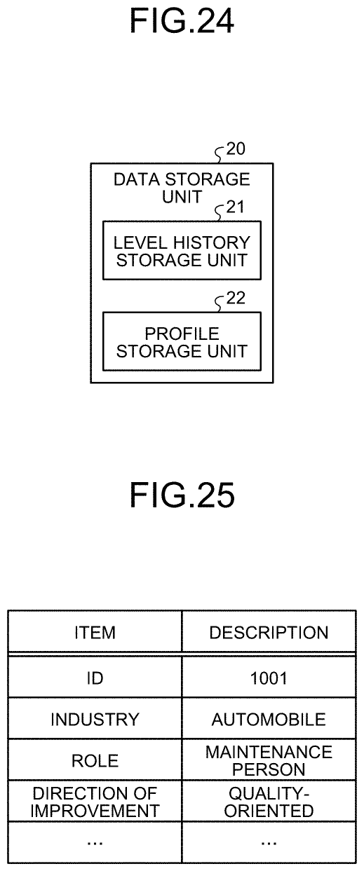

FIG. 24 is a block diagram illustrating the data storage unit 20 of the IT utilization evaluation device 100 according to a first modification of the first embodiment. In the first modification, the data storage unit 20 includes the level history storage unit 21 and a profile storage unit 22. The profile storage unit 22 stores first profile data indicating the profile of the IT utilization evaluation device 100, which is the first device, and second profile data indicating the profile of the IT utilization evaluation device 101, which is the second device. A profile is information by which the attributes of the user can be defined.

The target level determination unit 18 extracts, from a set of level history data stored in the level history storage unit 21, level history data having an association with the second profile data including a description identical to a description of the first profile data. The target level determination unit 18 determines a target level on the basis of the level history data including the combination of the same values as the combination of current attainment levels among the extracted level history data. In the following description, the first profile data may be referred to as “own profile data”, and the second profile data may be referred to as “other-device profile data”.

FIG. 25 is a diagram for explaining the contents of profile data stored in the profile storage unit 22 of the data storage unit 20 illustrated in FIG. 24. FIG. 25 depicts the contents of own profile data. The profile data include the ID assigned to the IT utilization evaluation device 100. “1001” for the item “ID” represents the ID of the IT utilization evaluation device 100.

The profile data include a description of the industry to which the supply chain 40 belongs, a description of the role of the user in managing the supply chain 40, and a description of the direction desired by the user in improving productivity. “Automobile” for the item “industry” indicates that the industry to which the supply chain 40 belongs is the automobile production industry. “Maintenance person” for the item “role” indicates that the user in managing the supply chain 40 is a maintenance person for the supply chain 40. “Quality-oriented” for the item “direction of improvement” indicates that the user wants to emphasize quality in improving productivity. Descriptions of “industry”, “role”, and “direction of improvement” in the profile data are input by the user. Like the IT utilization evaluation device 100, the IT utilization evaluation device 101 holds profile data. The items of profile data may include items by which the attributes of the user can be defined, in addition to the items “industry”, “role”, and “direction of improvement”.

The server 200 illustrated in FIG. 16 holds the profile data of the IT utilization evaluation device 100 and the profile data of each IT utilization evaluation device 101. The server 200 provides the held profile data to all the IT utilization evaluation devices 100 and 101. The communication unit 12 illustrated in FIG. 1 transmits the own profile data to the server 200. The communication unit 12 receives the other-device profile data transmitted from the server 200.

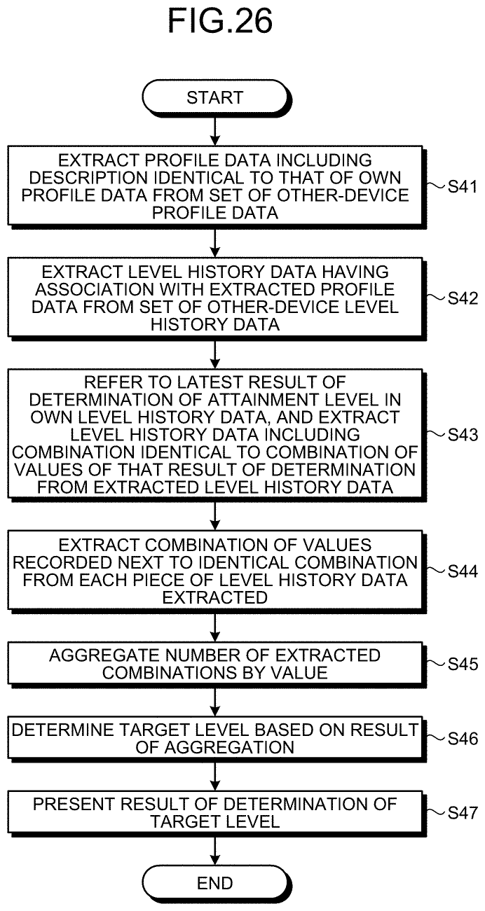

FIG. 26 is a flowchart illustrating the operation procedure for determining and presenting a target level by the IT utilization evaluation device 100 according to the first modification of the first embodiment. In step S41, the target level determination unit 18 refers to the profile data stored in the profile storage unit 22, and extracts profile data including a description identical to that of the own profile data, from a set of other-device profile data.

The target level determination unit 18 focuses on one of the items in the profile data as an item of interest, and extracts profile data including identical descriptions of the item of interest. For example, the target level determination unit 18 focuses on the item “industry”, and extracts other-device profile data including “automobile”. The target level determination unit 18 may extract profile data including identical descriptions of two or more items. The target level determination unit 18 may extract other-device profile data including a description determined as being highly related to a description included in the own profile data. The target level determination unit 18 may extract not only profile data including identical descriptions but also profile data including descriptions determined as having high relevance. The criterion for determining whether the relevance is high may be set by the user.

In step S42, the target level determination unit 18 extracts, from a set of other-device level history data, level history data having an association with the profile data extracted in step S41. The level history data having an association are the level history data having the ID identical to the ID included in the profile data.

In step S43, the target level determination unit 18 refers to the latest result of determination of the attainment level in the own level history data. The target level determination unit 18 extracts, from the level history data extracted in step S42, level history data including a combination identical to the combination of values of the referred result of determination. In step S44, the target level determination unit 18 extracts, from each piece of level history data extracted in step S43, the combination of values recorded next to the combination identical to the combination referred to in step S43.

In step S45, the target level determination unit 18 aggregates the number of combinations extracted in step S44 by value. In step S46, the target level determination unit 18 determines a target level on the basis of the result of aggregation in step S45. In step S47, the presentation unit 14 presents the result of determination of the target level in step S46. Then, the IT utilization evaluation device 100 ends the operation illustrated in FIG. 26.

According to the first modification of the first embodiment, the IT utilization evaluation device 100 causes the target level determination unit 18 to extract level history data associated with profile data including a description identical to a description of the own profile data. The user can formulate an IT introduction plan by emphasizing the past IT introduction tendency of another user having the same attributes as the user.

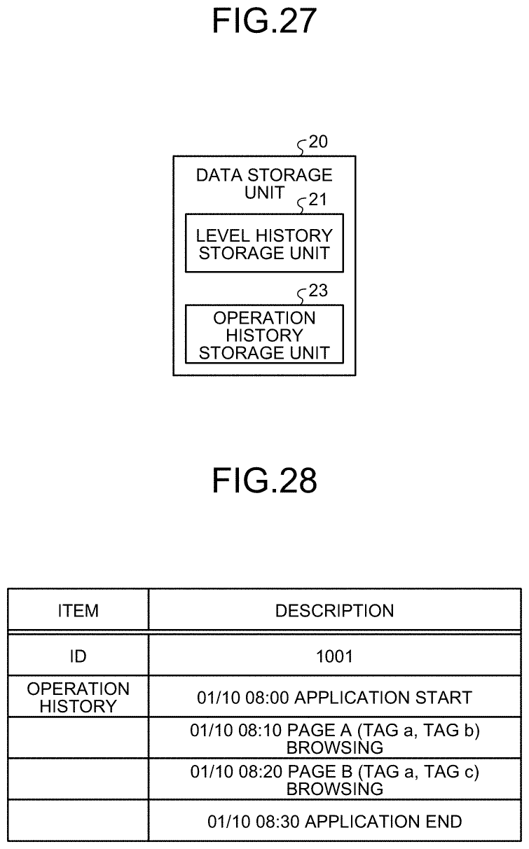

FIG. 27 is a block diagram illustrating the data storage unit 20 of the IT utilization evaluation device 100 according to a second modification of the first embodiment. In the second modification, the data storage unit 20 includes the level history storage unit 21 and an operation history storage unit 23. The operation history storage unit 23 stores first operation history data and second operation history data. The first operation history data indicates a history of operations by the IT utilization evaluation device 100, which is the first device. The second operation history data indicates a history of operations by the IT utilization evaluation device 101, which is the second device.

In the second modification, operation history data includes data indicating a history of starting and ending the application, namely the IT utilization evaluation program, and data indicating a history of browsing a specific screen displayed by the function of the application.

The target level determination unit 18 extracts, from a set of level history data stored in the level history storage unit 21, level history data having an association with the second operation history data including a description identical to a description of the first operation history data. The target level determination unit 18 determines a target level on the basis of the level history data including the combination of the same values as the combination of current attainment levels among the extracted level history data. In the following description, the first operation history data may be referred to as “own operation history data”, and the second operation history data may be referred to as “other-device operation history data”.

FIG. 28 is a diagram for explaining the contents of operation history data stored in the operation history storage unit 23 of the data storage unit 20 illustrated in FIG. 27. FIG. 28 depicts the contents of own operation history data. The operation history data include the ID assigned to the IT utilization evaluation device 100. “1001” for the item “ID” represents the ID of the IT utilization evaluation device 100.

“01/10 08:00 application start” for the item “operation history” indicates that the application was started at 8:00 on January 10. “01/10 08:10 page A (tag a, tag b) browsing” for the item “operation history” indicates that the screen specified by tag a and the screen specified by tag b in page A which is a specific screen were browsed at 8:10 on January 10. Like the IT utilization evaluation device 100, the IT utilization evaluation device 101 holds operation history data. Operation history data may include data indicating a history of other operations by the function of the application, in addition to the start and end of the application and the browsing of a specific screen.

The server 200 illustrated in FIG. 16 holds the operation history data of the IT utilization evaluation device 100 and the operation history data of each IT utilization evaluation device 101. The server 200 provides the held operation history data to all the IT utilization evaluation devices 100 and 101. The communication unit 12 illustrated in FIG. 1 transmits the own operation history data to the server 200. The communication unit 12 receives the other-device operation history data transmitted from the server 200.

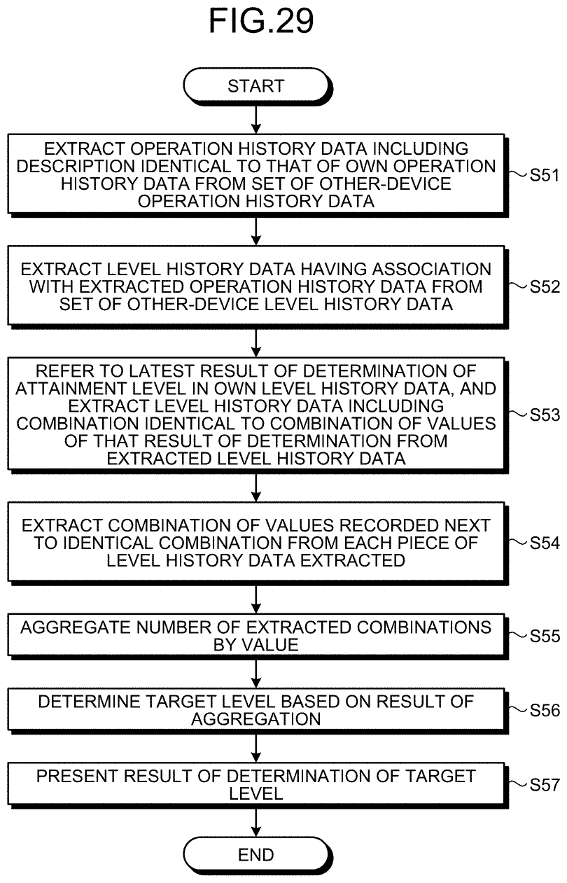

FIG. 29 is a flowchart illustrating the operation procedure for determining and presenting a target level by the IT utilization evaluation device 100 according to the second modification of the first embodiment. In step S51, the target level determination unit 18 refers to the operation history data stored in the operation history storage unit 23, and extracts, from a set of other-device operation history data, operation history data including a description identical to that of the own operation history data.

The target level determination unit 18 focuses on one of the operations recorded in the operation history data, as an operation of interest, and extracts other-device operation history data including a record of an operation identical to the operation of interest in the own operation history data. The target level determination unit 18 may extract other-device operation history data including a record of an operation identical to the operation of interest within a certain period from the date and time of the operation of interest in the own operation history data. For example, the target level determination unit 18 focuses on the start of the application, and extracts other-device operation history data including a record of the start of the application within one week from the start of the application in the own operation history data. The target level determination unit 18 may focus on the browsing of the screen designated by tag a and the screen designated by tag b in page A, and extract other-device operation history data including a character string of “page A (tag a, tag b) browsing”. The target level determination unit 18 may extract profile data including a record of two or more types of identical operations. Operations of interest may be set by the user.

In step S52, the target level determination unit 18 extracts, from a set of other-device level history data, level history data having an association with the operation history data extracted in step S51. The level history data having an association are the level history data having the ID identical to the ID included in the operation history data.

Starting the application displays the screen. Displayed on this screen are an instance where the attainment level of the first evaluation element and the second evaluation element has been brought to a specific attainment level, and information on IT products introduced to achieve the specific attainment level. The user performs an operation of displaying such information when formulating an IT introduction plan for achieving the desired attainment level. If a record of the start of the application within a certain period from the record of the start of the application in the own operation history data is included in other-device operation history data, it can be inferred that the other user, i.e. the user of the second device, also aims to increase the attainment level, like the user of the first device. In addition, if identical operations for displaying a screen related to the achievement of a specific attainment level are recorded in the own operation history data and other-device operation history data, it can be inferred that the other user has also aimed to achieve the attainment level that is the same as the specific attainment level. The target level determination unit 18 collects other-device operation history data including a record of an operation identical to that of the own operation history data. As a result, even though the target level determination unit 18 does not have information on the attainment level aimed at by another user, the target level determination unit 18 can learn the tendency of IT introduction by another user having a record of aiming to increase the attainment level in the same manner as the user of the IT utilization evaluation device 100.

In step S53, the target level determination unit 18 refers to the latest result of determination of the attainment level in the own level history data. The target level determination unit extracts, from the level history data extracted in step S52, level history data including a combination identical to the combination of values of the referred result of determination. In step S54, the target level determination unit 18 extracts, from each piece of level history data extracted in step S53, the combination of values recorded next to the combination identical to the combination referred to in step S53.

In step S55, the target level determination unit 18 aggregates the number of combinations extracted in step S54 by value. In step S56, the target level determination unit 18 determines a target level on the basis of the result of aggregation in step S55. In step S57, the presentation unit 14 presents the result of determination of the target level in step S56. Then, the IT utilization evaluation device 100 ends the operation illustrated in FIG. 29.

According to the second modification of the first embodiment, the IT utilization evaluation device 100 causes the target level determination unit 18 to extract level history data associated with operation history data including a description identical to a description of the own operation history data. The user can formulate an IT introduction plan by emphasizing the past IT introduction tendency of another user who has performed the same operation as the user.

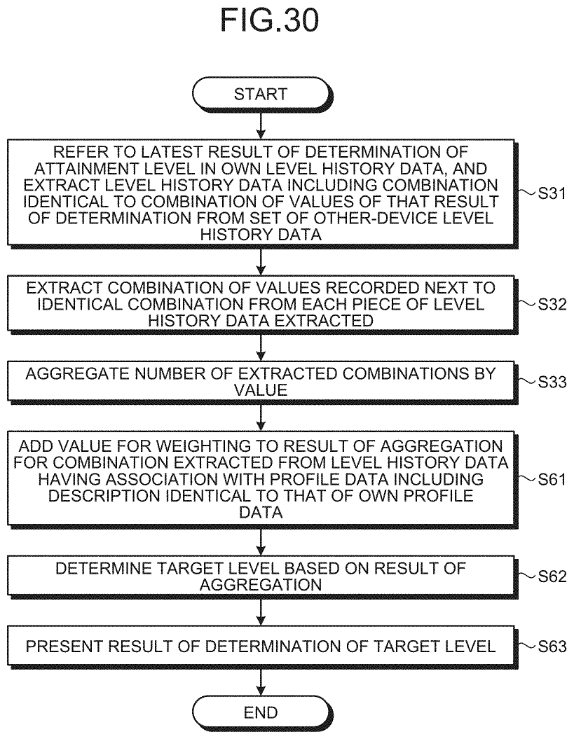

FIG. 30 is a flowchart illustrating the operation procedure for determining and presenting a target level by the IT utilization evaluation device 100 according to a third modification of the first embodiment. The data storage unit 20 of the IT utilization evaluation device 100 according to the third modification of the first embodiment includes the profile storage unit 22 as in the first modification. In the third modification of the first embodiment, for the IT utilization evaluation device 101 having other-device profile data including a description identical to that of the own profile data, the target level determination unit 18 adds a value for weighting to the result of aggregation described above.

The processes of steps S31 to S33 illustrated in FIG. 30 are the same as the processes of steps S31 to step S33 illustrated in FIG. 18. In step S61, the target level determination unit 18 adds a value for weighting to the result of aggregation for a combination extracted from the level history data having an association with the profile data including a description identical to that of the own profile data. The level history data having an association are the level history data having the ID identical to the ID included in the profile data.

For example, the target level determination unit 18 adds, to the result of aggregation, a value for doubling the count for a combination extracted from the level history data having an association with the profile data including a description identical to that of the own profile data. The target level determination unit 18 may add, to the result of aggregation, a value for more than doubling the count for the combination. The target level determination unit 18 may add, to the result of aggregation, a value that increases the multiplying factor of the count for the combination as the number of items having identical descriptions increases.

In step S62, the target level determination unit 18 determines a target level based on the results of aggregation in steps S33 and S61. In step S63, the presentation unit 14 presents the result of determination of the target level in step S62. Then, the IT utilization evaluation device 100 ends the operation illustrated in FIG. 30.

According to the third modification of the first embodiment, the IT utilization evaluation device 100 adds a value for weighting to the result of aggregation for a combination extracted from the level history data associated with the profile data including a description identical to that of the own profile data. The IT utilization evaluation device 100 can present the target level determined by emphasizing the past IT introduction tendency of another user having the same attributes as the user. The user can formulate an IT introduction plan by emphasizing the past IT introduction tendency of another user having the same attributes.

In the third modification, the IT utilization evaluation device 100 may add a value for weighting to the result of aggregation for a combination extracted from the level history data associated with the operation history data including a description identical to that of the own operation history data. The IT utilization evaluation device 100 can present the target level determined by emphasizing the past IT introduction tendency of another user who has performed the same operation. The user can formulate an IT introduction plan by emphasizing the past IT introduction tendency of another user who has performed the same same operation as the user.

### Second Embodiment

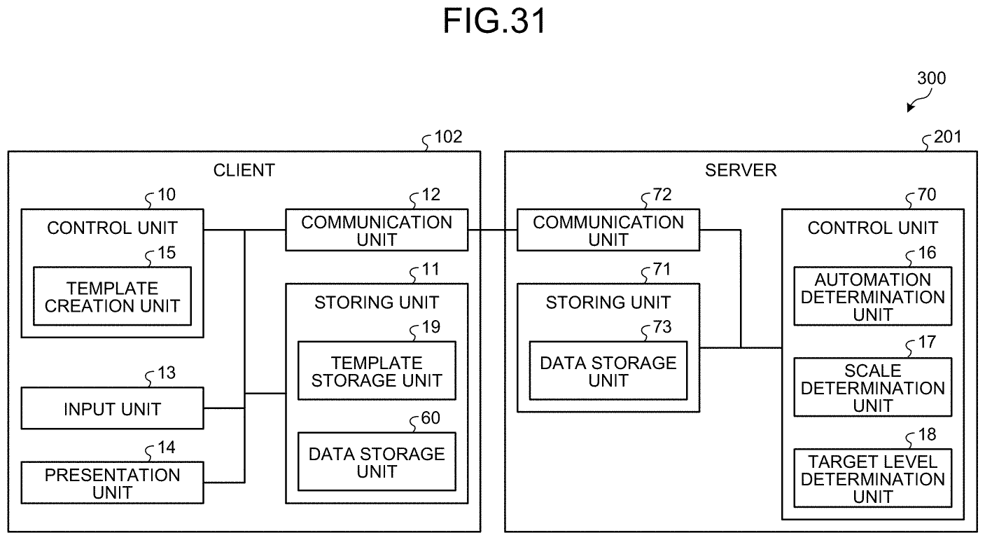

FIG. 31 is a block diagram illustrating a functional configuration of an IT utilization evaluation system 300 according to the second embodiment of the present invention. In the IT utilization evaluation system 300, the functions similar to those of the IT utilization evaluation device 100 according to the first embodiment are separated into a client 102 and a server 201 which define the IT utilization evaluation system 300. In the second embodiment, parts identical to those in the first embodiment are denoted by the same reference signs, and configurations different from those in the first embodiment will be mainly described.

The client 102 and the server 201 are connected via the communication network 110 similar to that in FIG. 16. In the second embodiment, the communication network 110 is not illustrated.

The client 102 is a computer with a program for executing a part of the IT utilization evaluation method similar to that of the first embodiment installed thereon. The server 201 is a computer with a program for executing the other part of the IT utilization evaluation method similar to that of the first embodiment installed thereon. Each functional unit of the client 102 and each functional unit of the server 201 illustrated in FIG. 31 are implemented by executing the program on the computer, which is hardware.

The control unit 10 is a functional unit that controls the entire client 102. The control unit 10 includes the template creation unit 15. The storing unit 11 includes the template storage unit 19 and a data storage unit 60. The data storage unit 60 is a functional unit that stores various data. The data storage unit 60 stores own level history data. The own level history data are level history data indicating a history of attainment levels determined by the server 201 for the client 102. The communication unit 12 is a functional unit that communicates with a device external to the client 102. The client 102 includes the input unit 13 and the presentation unit 14 like the IT utilization evaluation device 100 according to the first embodiment.

The server 201 includes a control unit 70, a storing unit 71, and a communication unit 72. The control unit 70 is a functional unit that controls the entire server 201. The storing unit 71 is a functional unit that stores information. The communication unit 72 is a functional unit that communicates with a device external to the server 201. The control unit 70 includes the automation determination unit 16, the scale determination unit 17, and the target level determination unit 18. The storing unit 71 includes a data storage unit 73 which is a functional unit that stores various data. The data storage unit 73 stores other-device level history data. The other-device level history data is level history data indicating a history of attainment levels determined by the server 201 for a client other than the client 102.

The client 102 is installed in the factory 41 of the user. In the second embodiment, the user is a person who requests the server 201 to evaluate the degree of IT utilization. Note that the client 102 may be installed in a place other than the factory 41.

The communication unit 12 transmits, to the server 201, the data on the number of targets and the number of hits input to the template 51 illustrated in FIG. 8. The communication unit 72 receives data from the client 102. The automation determination unit 16 determines the attainment level of the first evaluation element, which is the progress of automation. The scale determination unit 17 determines the attainment level of the second evaluation element, which is the scale of a set in which IT is utilized. The communication unit 72 transmits, to the client 102, the result of determination by the automation determination unit 16 and the result of determination by the scale determination unit 17. The communication unit 12 of the client 102 receives the result of determination from the server 201. The data storage unit 60 constructs own level history data by accumulating the results of determination received. The communication unit 12 transmits the constructed own level history data to the server 201. The data storage unit 73 stores the received level history data.

The automation determination unit 16 determines the attainment level of the first evaluation element not only for the client 102 but also for a client other than the client 102. The scale determination unit 17 of the server 201 determines the attainment level of the second evaluation element not only for the client 102 but also for a client other than the client 102. The data storage unit 73 of the server 201 constructs other-device level history data by accumulating the results of determination for a client other than the client 102.

The target level determination unit 18 determines a target level for the client 102 on the basis of the other-device level history data stored in the data storage unit 73. The communication unit 72 transmits, to the client 102, the result of determination of the target level by the target level determination unit 18. The presentation unit 14 presents the received result of determination of the target level.

The data storage unit 73 may store other-device profile data, like the data storage unit 20 of the first modification of the first embodiment. The target level determination unit 18 extracts, from a set of level history data stored in the data storage unit 73, level history data having an association with the other-device profile data including a description identical to a description of the own profile data.

The data storage unit 73 may store other-device operation history data, like the data storage unit 20 of the second modification of the first embodiment. The target level determination unit 18 extracts, from a set of level history data stored in the data storage unit 73, level history data having an association with the other-device operation history data including a description identical to a description of the own operation history data.

The target level determination unit 18 may add a value for weighting to the result of aggregation for a client in which a description identical to that of the own profile data is included in the profile data, as in the third modification of the first embodiment. The target level determination unit 18 may add a value for weighting to the result of aggregation for a client in which a description identical to that of the own operation history data is included in the operation history data.

The client 102 may be a mobile terminal such as a smartphone or a tablet terminal. An application for implementing each functional unit of the client 102 illustrated in FIG. 31 is installed on the mobile terminal. The function of the input unit 13 and the function of the presentation unit 14 are implemented using the touch panel of the mobile terminal. The number of IT introduction targets and the number of IT introduction hits are input to the template through user's manual input on the mobile terminal. The mobile terminal transmits the input information to the server 201. The server 201 transmits, to the mobile terminal, the result of determination of the first attainment level and the second attainment level and the result of determination of the target level. The mobile terminal presents the received result of determination.

According to the second embodiment, the IT utilization evaluation system 300 includes the target level determination unit 18. The target level determination unit 18 determines a target level, i.e. an attainment level recommended as a target, from the current attainment level for the first evaluation element and the second evaluation element. From the client 102 in which a combination identical to the combination of current attainment levels is recorded in the level history data, the attainment level having the highest frequency among the attainment levels recorded next to the identical combination is designated as a target level, whereby the user can formulate an IT introduction plan with reference to the past IT introduction tendency. As a result, the IT utilization evaluation system 300 can achieve the effect of obtaining guidelines on future target levels on the basis of the current state of IT utilization.

### Third Embodiment

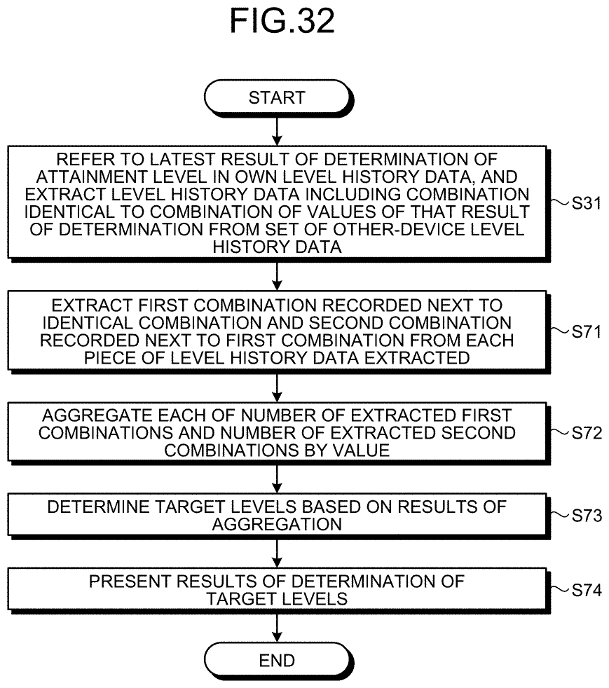

FIG. 32 is a flowchart illustrating the operation procedure of the IT utilization evaluation device 100 according to the third embodiment of the present invention. In the IT utilization evaluation device 100 according to the third embodiment, the target level determination unit 18 extracts, from other-device level history data including the combination of the same values as the combination of the latest result of determination, a first combination that is a combination of values recorded next to the combination of the same values and a second combination that is a combination of values recorded after the first combination. In the third embodiment, parts identical to those in the first and second embodiments are denoted by the same reference signs, and configurations different from those in the first and second embodiments will be mainly described.

Step S31 illustrated in FIG. 32 is the same as step S31 illustrated in FIG. 18. In step S71, the target level determination unit 18 extracts, from each piece of level history data extracted in step S31, the first combination recorded next to the combination identical to the combination referred to in step S31, and the second combination recorded next to the first combination. Assume that the combination as the latest result of determination of the attainment level is “2B”, and the level history data of one IT utilization evaluation device 101 include a time series of combinations “1A”, “2A”, “2B”, “3B”, “3C”, and “4C”. In this case, the target level determination unit 18 extracts, from the level history data, the first combination “3B” recorded next to “2B” and the second combination “3C” recorded next to “3B”.

In step S72, the target level determination unit 18 aggregates, by value, each of the number of first combinations extracted in step S71 and the number of second combinations extracted in step S71. In step S73, the target level determination unit 18 determines target levels on the basis of the results of aggregation in step S72. The target level determination unit 18 determines the target level to be achieved next to the current attainment level on the basis of the result of aggregation of the number of first combinations. The target level determination unit 18 determines the target level to be achieved next to that target level on the basis of the result of aggregation of the number of second combinations. In step S74, the presentation unit 14 presents the results of determination of target levels in step S73. Then, the IT utilization evaluation device 100 ends the operation illustrated in FIG. 32.

According to the third embodiment, the IT utilization evaluation device 100 can obtain the target level that is the attainment level recommended as a target from the current attainment level, and the target level that is the attainment level recommended as a target from that target level.

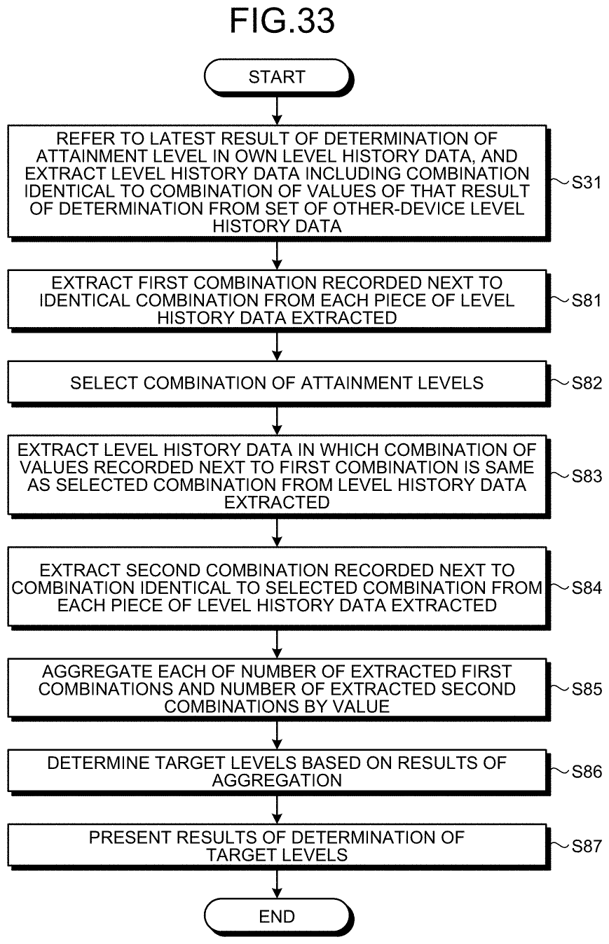

FIG. 33 is a flowchart illustrating the operation procedure of the IT utilization evaluation device 100 according to a first modification of the third embodiment. In the first modification of the third embodiment, the target level determination unit 18 selects a combination of attainment levels.

Step S31 illustrated in FIG. 33 is the same as step S31 illustrated in FIG. 18. In step S81, the target level determination unit 18 extracts, from each piece of level history data extracted in step S31, the first combination recorded next to the combination identical to the combination referred to in step S31. For example, assume that the combination as the latest result of determination of the attainment level is “2B”, and the level history data of one IT utilization evaluation device 101 include a time series of combinations “1A”, “2A”, “2B”, “2C”, “3B”, “3C”, and “3D”. In this case, the target level determination unit 18 extracts, from the level history data, the first combination “2C” recorded next to “2B”.

In step S82, the target level determination unit 18 selects a combination of attainment levels. The target level determination unit 18 selects a combination of attainment levels through user's manual input. The user can specify any combination as the combination that is selected in step S82.

In step S83, the target level determination unit 18 extracts, from the level history data extracted in step S31, level history data in which the combination of values recorded next to the first combination is the same as the combination selected in step S82. In a case where the combination selected in step S82 is “3B”, the target level determination unit 18 extracts level history data including “3B” next to the first combination “2C”, such as the above series of combinations “1A”, “2A”, “2B”, “2C”, “3B”, “3C”, and “3D”.

In step S84, the target level determination unit 18 extracts, from each piece of level history data extracted in step S83, the second combination, i.e. the combination recorded next to the combination identical to the selected combination. From the series of combinations “1A”, “2A”, “2B”, “3B”, “3C”, and “3D”, the target level determination unit 18 selects the second combination “3C” recorded next to the combination “3B” selected in step S82.

In step S85, the target level determination unit 18 aggregates, by value, each of the number of first combinations extracted in step S81 and the number of second combinations extracted in step S84. In step S86, the target level determination unit 18 determines target levels on the basis of the results of aggregation in step S85. The target level determination unit 18 determines the target level to be achieved next to the current attainment level on the basis of the result of aggregation of the number of first combinations. On the basis of the result of aggregation of the number of second combinations, the target level determination unit 18 determines the target level to be achieved next to the selected combination next to that target level. In step S87, the presentation unit 14 presents the results of determination of target levels in step S86. Then, the IT utilization evaluation device 100 ends the operation illustrated in FIG. 33.

According to the first modification of the third embodiment, the IT utilization evaluation device 100 can present the target level that is the attainment level recommended as a target from the current attainment level, and the target level that is the attainment level recommended as a target from the selected combination next to that target level.

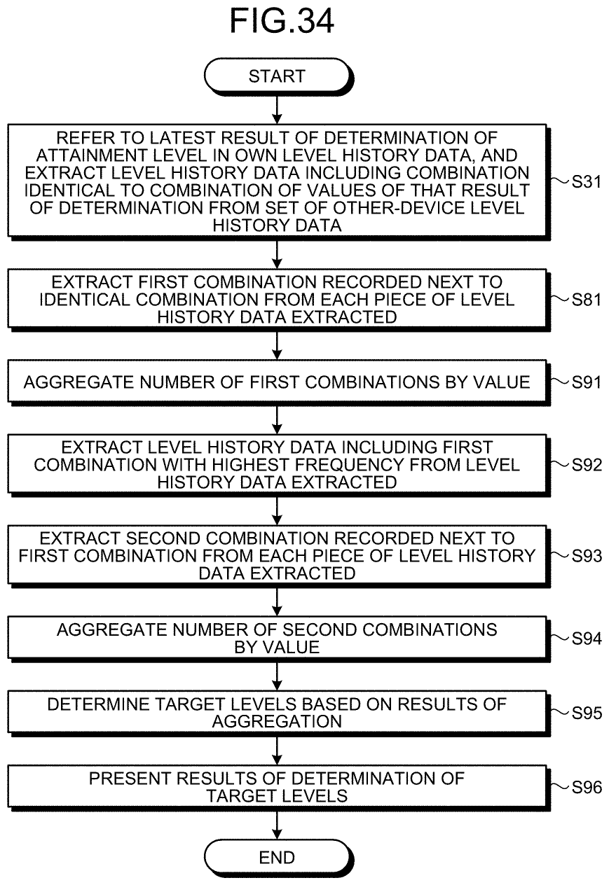

FIG. 34 is a flowchart illustrating the operation procedure of the IT utilization evaluation device 100 according to a second modification of the third embodiment. In the second modification of the third embodiment, the target level determination unit 18 extracts the second combination from each piece of level history data including the first combination having the highest frequency.

Step S31 illustrated in FIG. 34 is the same as step S31 illustrated in FIG. 18. Step S81 illustrated in FIG. 34 is the same as step S81 illustrated in FIG. 33. In step S91, the target level determination unit 18 aggregates the number of first combinations extracted in step S81 by value.

In step S92, the target level determination unit 18 extracts, from the level history data extracted in step S31, level history data including the first combination having the highest frequency. For example, assume that the combination as the latest result of determination of the attainment level is “2B”, and the level history data of one IT utilization evaluation device 101 include a time series of combinations “1A”, “2A”, “2B”, “2C”, “3B”, “3C”, and “3D”. In this case, the target level determination unit 18 extracts the first combination “2C” in step S81. In a case where the first combination having the highest frequency is “2C”, the target level determination unit 18 extracts level history data including that time series.

In step S93, the target level determination unit 18 extracts, from each piece of level history data extracted in step S92, the second combination recorded next to the first combination. From the above series of combinations “1A”, “2A”, “2B”, “2C”, “3B”, “3C”, and “3D”, the target level determination unit 18 extracts the second combination “3B” recorded next to the first combination “2C”. In step S94, the target level determination unit 18 aggregates the number of second combinations extracted in step S93 by value.

In step S95, the target level determination unit 18 determines target levels on the basis of the result of aggregation in step S91 and the result of aggregation in step S94. On the basis of the result of aggregation of the number of first combinations, the target level determination unit 18 determines the target level to be achieved next to the current attainment level. On the basis of the result of aggregation of the number of second combinations, the target level determination unit 18 determines the target level to be achieved next to that target level. In step S96, the presentation unit 14 presents the results of determination of target levels in step S95. Then, the IT utilization evaluation device 100 ends the operation illustrated in FIG. 34.

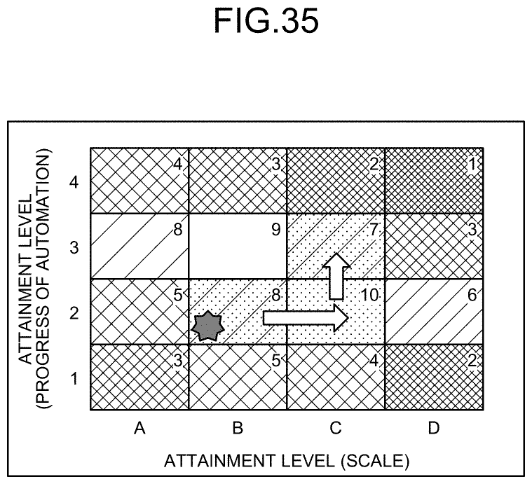

FIG. 35 is a diagram illustrating an example of presenting target levels by the presentation unit 14 of the IT utilization evaluation device 100 according to the third embodiment. The presentation unit 14 shows the target level to be achieved next to the current attainment level with an arrow pointing from the cell representing the current attainment level to the cell representing the target level. With an arrow from the cell representing that target level, the presentation unit 14 shows another target level to be achieved next to the target level next to the current attainment level. As a result, the presentation unit 14 can present, to the user in an easy-to-understand manner, the transition of the attainment level recommended from the current attainment level.

According to the third embodiment, the IT utilization evaluation device 100 can extract the first combination and the second combination from the level history data to thereby determine the target level next to the current attainment level and another target level next to that target level. The IT utilization evaluation device 100 can obtain the transition of the attainment level recommended from the current attainment level. As a result, the IT utilization evaluation device 100 can achieve the effect of obtaining guidelines on future target levels based on the current state of IT utilization. In the same manner as the target level determination unit 18 of the third embodiment, the target level determination unit 18 of the server 201 of the second embodiment may determine the target level next to the current attainment level and another target level next to that target level.

### Fourth Embodiment

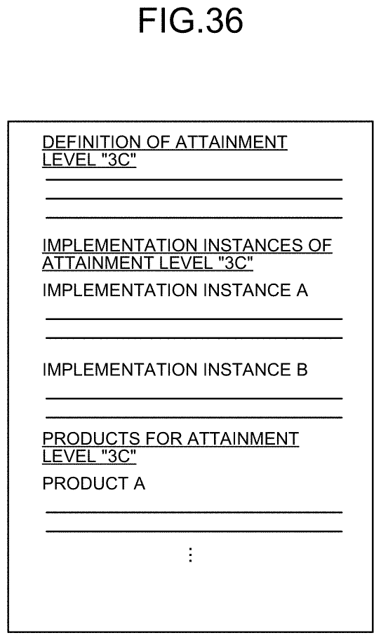

FIG. 36 is a diagram illustrating an example of information presented by the presentation unit 14 of the IT utilization evaluation device 100 according to the fourth embodiment of the present invention. In the fourth embodiment, the presentation unit 14 presents information that serves as a suggestion for bringing the attainment level of the first evaluation element and the second evaluation element to a target level. In the fourth embodiment, parts identical to those in the first to third embodiments are denoted by the same reference signs, and configurations different from those in the first to third embodiments will be mainly described.

In response to an operation of designating an attainment level on the screen for presenting target levels as illustrated in FIG. 22, the presentation unit 14 presents information about the designated attainment level. FIG. 36 depicts an example in which information on the attainment level “3C” is presented, including the definition, implementation instances, and products.

According to the fourth embodiment, the IT utilization evaluation device 100 presents information that serves as a suggestion for bringing the attainment level of the first evaluation element and the second evaluation element to a target level. The user can formulate an IT introduction plan with reference to the presented information. As a result, the IT utilization evaluation device 100 can achieve the effect of presenting information that can be referred to for IT introduction.

The configurations described in the above-mentioned embodiments indicate examples of the contents of the present invention. The configurations can be combined with another well-known technique, and some of the configurations can be omitted or changed in a range not departing from the gist of the present invention.

### REFERENCE SIGNS LIST

10, 70 control unit; 11, 71 storing unit; 12, communication unit; 13 input unit; 14 presentation unit; 15 template creation unit; 16 automation determination unit; 17 scale determination unit; 18 target level determination unit; 19 template storage unit; 20, 60, 73 data storage unit; 21 level history storage unit; 22 profile storage unit; 23 operation history storage unit; 31 CPU; 32 RAM; 33 ROM; 34 external storage device; 35 communication I/F; 36 input device; 37 display; 38 bus; 40 supply chain; 41 factory; 42 material manufacturer; 43 parts manufacturer; 44 procurement department; 45A, 45B, 45C shop; 46 product storage department; 47 logistics department; 48 sales department; 50 input format; 51 template; 100, 101 IT utilization evaluation device; 102 client; 110 communication network; 200, 201 server; 300 IT utilization evaluation system.

1. An information technology utilization evaluation device to evaluate a degree of information technology utilization in process management for a process to be managed, the process including a set of unitary processes, the information technology utilization evaluation device comprising:
a processor to execute a program; and
a memory to store the program which, when executed by the processor, performs:
a first attainment level determination process of determining a first attainment level by evaluating a current state of a first evaluation element, the first attainment level being a current attainment level of the first evaluation element, the first evaluation element being progress of automation of the process management;
a second attainment level determination process of a second attainment level by evaluating a current state of a second evaluation element, the second attainment level being a current attainment level of the second evaluation element, the second evaluation element being scale of the set in which information technology is utilized for the process management; and
a target level determination process of determining a target level, using the first attainment level and the second attainment level, the target level being an attainment level recommended as a target.

2. The information technology utilization evaluation device according to claim 1, comprising
a level history storage to store level history data indicating a history of attainment levels previously determined, wherein
the target level determination process determines the target level by referring, from the level history data stored in the level history storage, to a transition of the first attainment level previously determined and a transition of the second attainment level previously determined.

3. The information technology utilization evaluation device according to claim 2, wherein the target level determination determines the target level by referring to a combination of values indicating a latest result of determination of the first attainment level and the second attainment level, and referring, from level history data including a combination of the same values as the combination among the level history data stored in the level history storage, to a transition of the first attainment level previously determined and a transition of the second attainment level previously determined.

4. The information technology utilization evaluation device according to claim 3, wherein the target level determination process extracts, from each piece of level history data including a combination of the same values as the combination among the level history data stored in the level history storage, a combination of values recorded next to the combination of the same values, aggregates the number of extracted combinations, and determines the target level based on a result of the aggregation.

5. The information technology utilization evaluation device according to claim 3, wherein the target level determination process extracts, from each piece of level history data including a combination of the same values as the combination among the level history data stored in the level history storage, a first combination that is a combination of values recorded next to the combination of the same values and a second combination that is a combination of values recorded after the first combination, and aggregates the number of first combinations and the number of second combinations.

6. The information technology utilization evaluation device according to claim 3, comprising
a profile storage to store first profile data indicating a profile of a first device that is the information technology utilization evaluation device and second profile data indicating a profile of a second device that is an information technology utilization evaluation device other than the first device, wherein
the target level determination process extracts, from a set of the level history data stored in the level history storage, level history data having an association with the second profile data including a description identical to a description of the first profile data, and determines the target level on a basis of level history data including the combination of the same values among the extracted level history data.

7. The information technology utilization evaluation device according to claim 3, comprising
an operation history data storage [[unit]] to store first operation history data indicating a history of operations by a first device that is the information technology utilization evaluation device, and second operation history data indicating a history of operations by a second device that is an information technology utilization evaluation device other than the first device, wherein
the target level determination process extracts, from a set of the level history data stored in the level history storage, level history data having an association with the second operation history data including a description identical to a description of the first operation history data, and determines the target level on a basis of level history data including the combination of the same values among the extracted level history data.

8. The information technology utilization evaluation device according to claim 1, comprising a presentation process of presenting a result of determination of the target level by the target level determination process.

9. The information technology utilization evaluation device according to claim 8, wherein the presentation process presents a result of determination of the first attainment level and the second attainment level.

10. The information technology utilization evaluation device according to claim 8, wherein the presentation process presents information that serves as a suggestion for bringing the first attainment level and the second attainment level to the target level.

11. An information technology utilization evaluation system to evaluate a degree of information technology utilization in process management for a process to be managed, the process including a set of unitary processes, the information technology utilization evaluation system comprising:
a processor to execute a program; and
a memory to store the program which, when executed by the processor, performs:
a first attainment level determination process of determining a first attainment level by evaluating a current state of a first evaluation element, the first attainment level being a current attainment level of the first evaluation element, the first evaluation element being progress of automation of the process management;
a second attainment level determination process of determining a second attainment level by evaluating a current state of a second evaluation element, the second attainment level being a current attainment level of the second evaluation element, the second evaluation element being scale of the set in which information technology is utilized for the process management; and
a target level determination process of determining a target level, using the first attainment level and the second attainment level, the target level being an attainment level recommended as a target.

12. The information technology utilization evaluation system according to claim 11, comprising:
a server connected to a network and including the processor and the memory; and
a client including a receiver to receive input information indicating a current state of information technology utilization, the client including a processor, and a memory to store a program which when executed by the processor, performs a presentation process of presenting a result of determination of the target level by the target level determination process, the client being connected to the network.

13. An information technology utilization evaluation method for evaluating a degree of information technology utilization in process management for a process to be managed, the process including a set of unitary processes, the method comprising:
determining a first attainment level by evaluating a current state of a first evaluation element, the first attainment level being a current attainment level of the first evaluation element, the first evaluation element being progress of automation of the process management;
determining a second attainment level by evaluating a current state of a second evaluation element, the second attainment level being a current attainment level of the second evaluation element, the second evaluation element being scale of the set in which information technology is utilized for the process management; and
determining a target level, using the first attainment level and the second attainment level, the target level being an attainment level recommended as a target.
